(19) United States
(12) Patent Application Publication
(10) Pub. No.: US 2023/0299902 A1
(43) Pub. Date: Sep. 21, 2023

(54) TA MEASUREMENT AND REPORTING WITH MULTIPLE TRANSMISSION AND RECEPTION POINTS

(71) Applicant: Samsung Electronics Co., Ltd., Suwon-si (KR)

(72) Inventors: Emad N. Farag, Flanders, NJ (US); Kyoungmin Park, Seoul (KR); Dalin Zhu, Richardson, TX (US); Eko Onggosanusi, Coppell, TX (US)

(21) Appl. No.: 18/177,744

(22) Filed: Mar. 2, 2023

Related U.S. Application Data
(60) Provisional application No. 63/320,075, filed on Mar. 15, 2022.
(60) Provisional application No. 63/335,074, filed on Apr. 26, 2022.
(60) Provisional application No. 63/395,634, filed on Aug. 5, 2022.
(60) Provisional application No. 63/397,211, filed on Aug. 11, 2022.
(60) Provisional application No. 63/422,843, filed on Nov. 4, 2022.

(51) Int. Cl. H04L 5/00; H04W 74/00

(52) U.S. Cl. CPC H04L 5/0035; H04W 74/004; H04L 5/0051

(57) ABSTRACT

Methods and apparatuses for reporting with multiple transmission and reception points in a wireless communication system. A method of operating a user equipment (UE) includes receiving configuration information for a first list of synchronization signal/physical broadcast channel (SS/PBCH) block indices associated with a first timing advance group (TAG) and a second list of SS/PBCH block indices associated with a second TAG, receiving a contention free random access (CFRA)-based physical downlink control channel (PDCCH) order, and transmitting a physical random access channel (PRACH) preamble in response to the CFRA-based PDCCH order. The method further includes receiving a random access response (RAR) in response to the PRACH preamble, including a timing advance (TA) command and determining a TAG associated with the TA command based on an SS/PBCH block index associated with the CFRA-based PDCCH order.

### CROSS-REFERENCE TO RELATED APPLICATIONS AND CLAIM OF PRIORITY

The present application claims priority to:
U.S. Provisional Patent Application No. 63/320,075, filed on Mar. 15, 2022;
U.S. Provisional Patent Application No. 63/335,074, filed on Apr. 26, 2022;
U.S. Provisional Patent Application No. 63/395,634, filed on Aug. 5, 2022;
U.S. Provisional Patent Application No. 63/397,211, filed on Aug. 11, 2022; and
U.S. Provisional Patent Application No. 63/422,843, filed on Nov. 4, 2022.

The contents of the above-identified patent documents are incorporated herein by reference.

### TECHNICAL FIELD

The present disclosure relates generally to wireless communication systems and, more specifically, the present disclosure relates to a reporting with multiple transmission and reception points in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a reporting with multiple transmission and reception points in a wireless communication system.

In one embodiment, a user equipment (UE) is provided. The UE includes a transceiver configured to receive configuration information for a first list of synchronization signal/physical broadcast channel (SS/PBCH) block indices associated with a first timing advance group (TAG) and a second list of SS/PBCH block indices associated with a second TAG, receive a contention free random access (CFRA)-based physical downlink control channel (PDCCH) order, transmit a physical random access channel (PRACH) preamble in response to the CFRA-based PDCCH order, and receive a random access response (RAR) in response to the PRACH preamble, including a timing advance (TA) command. The UE further includes a processor operably coupled to the transceiver, the processor configured to determine a TAG associated with the TA command based on an SS/PBCH block index associated with the CFRA-based PDCCH order.

In another embodiment, a base station (BS) is provided. The BS includes a transceiver configured to transmit configuration information for a first list of SS/PBCH block indices associated with a first TAG and a second list of SS/PBCH block indices associated with a second TAG, transmit a CFRA-based PDCCH order, receive a PRACH preamble in response to the CFRA-based PDCCH order, and transmit a RAR in response to the PRACH preamble, including a TA command. The BS further includes a processor operably coupled to the transceiver, the processor configured to determine a TAG associated with the TA command based on an SS/PBCH block index associated with the CFRA-based PDCCH order.

In yet another embodiment, a method of operating a UE is provided. The method includes receiving configuration information for a first list of SS/PBCH block indices associated with a first TAG and a second list of SS/PBCH block indices associated with a second TAG, receiving a CFRA-based PDCCH order, and transmitting a PRACH preamble in response to the CFRA-based PDCCH order. The method further includes receiving a RAR in response to the PRACH preamble, including a TA command and determining a TAG associated with the TA command based on an SS/PBCH block index associated with the CFRA-based PDCCH order.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of OFDM symbol according to embodiments of the present disclosure;

FIG. 9 illustrates an example of FFT window according to embodiments of the present disclosure;

FIG. 10A illustrates an example of type-1 random access procedure according to embodiments of the present disclosure;

FIG. 10B illustrates an example of type-2 random access procedure according to embodiments of the present disclosure;

FIG. 11A illustrates an example of UE communication with TRP A and TRP B according to embodiments of the present disclosure;

FIG. 11B illustrates an example of UE communication with TRP A and TRP B according to embodiments of the present disclosure;

FIG. 12 illustrates an example of symbol and slot according to embodiments of the present disclosure;

FIG. 13 illustrates an example of UE communication with TRP A and TRP B according to embodiments of the present disclosure;

FIG. 14 illustrates an example of symbol and slot according to embodiments of the present disclosure;

FIG. 15 illustrates an example of configuration of SSBs according to embodiments of the present disclosure;

FIG. 16 illustrates an example of entities for TRP according to embodiments of the present disclosure;

FIG. 17 illustrates another example of entities for TRP according to embodiments of the present disclosure;

FIG. 18 illustrates yet another example of entities for TRP according to embodiments of the present disclosure;

FIG. 19 illustrates yet another example of entities for TRP according to embodiments of the present disclosure;

FIG. 20 illustrates yet another example of entities for TRP according to embodiments of the present disclosure;

FIG. 21 illustrates yet another example of entities for TRP according to embodiments of the present disclosure;

FIG. 22 illustrates an example of higher-layer triggered CFRA procedure according to embodiments of the present disclosure;

FIG. 23 illustrates an example of higher-layer triggered CBRA procedure according to embodiments of the present disclosure;

FIG. 24 illustrates an example of PDCCH order triggered CFRA or CBRA procedure according to embodiments of the present disclosure;

FIG. 25 illustrates an example of signaling flow for a preamble transmission based on SS/PBCH according to embodiments of the present disclosure;

FIG. 26 illustrates another example of signaling flow for a preamble transmission based on SS/PBCH according to embodiments of the present disclosure;

FIG. 27 illustrates yet another example of signaling flow for a preamble transmission based on SS/PBCH according to embodiments of the present disclosure;

FIG. 28 illustrates yet another example of signaling flow for a preamble transmission based on SS/PBCH according to embodiments of the present disclosure;

FIG. 29 illustrates yet another example of signaling flow for a preamble transmission based on SS/PBCH according to embodiments of the present disclosure; and

FIG. 30 illustrates an example of two UL transmissions overlap according to embodiments of the present disclosure.

### DETAILED DESCRIPTION

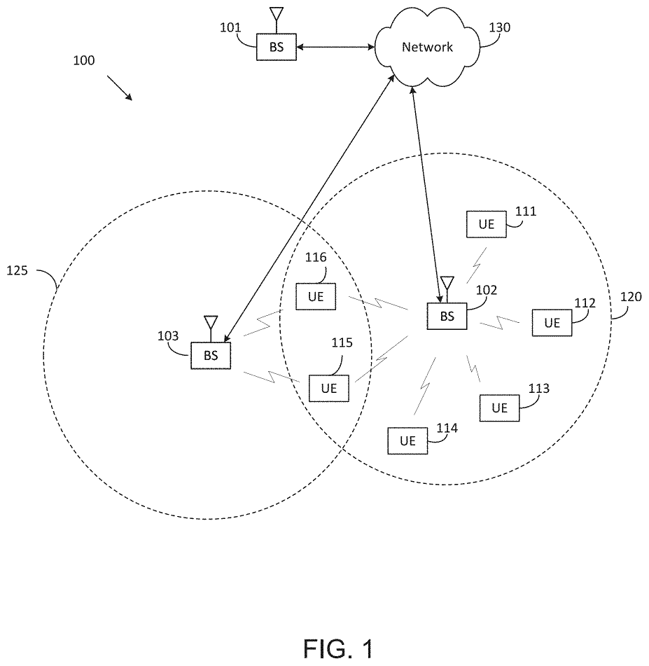

FIG. 1 through FIG. 30, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.1.0, “NR; Physical channels and modulation”; 3GPP TS 38.212 v17.1.0, “NR; Multiplexing and Channel coding”; 3GPP TS 38.213 v17.1.0, “NR; Physical Layer Procedures for Control”; 3GPP TS 38.214 v17.1.0, “NR; Physical Layer Procedures for Data”; 3GPP TS 38.321 v17.1.0, “NR; Medium Access Control (MAC) protocol specification”; and 3GPP TS 38.331 v17.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a reporting with multiple transmission and reception points in a wireless communication system. In certain embodiments, and one or more of the gNBs 101-103 includes circuitry, programing, or a combination thereof, for a reporting with multiple transmission and reception points in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

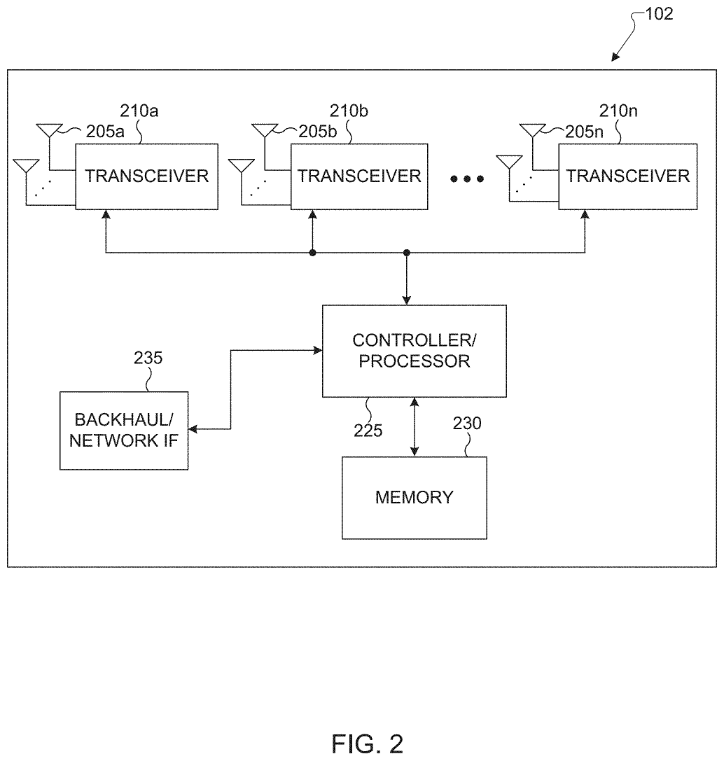

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for a reporting with multiple transmission and reception points in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

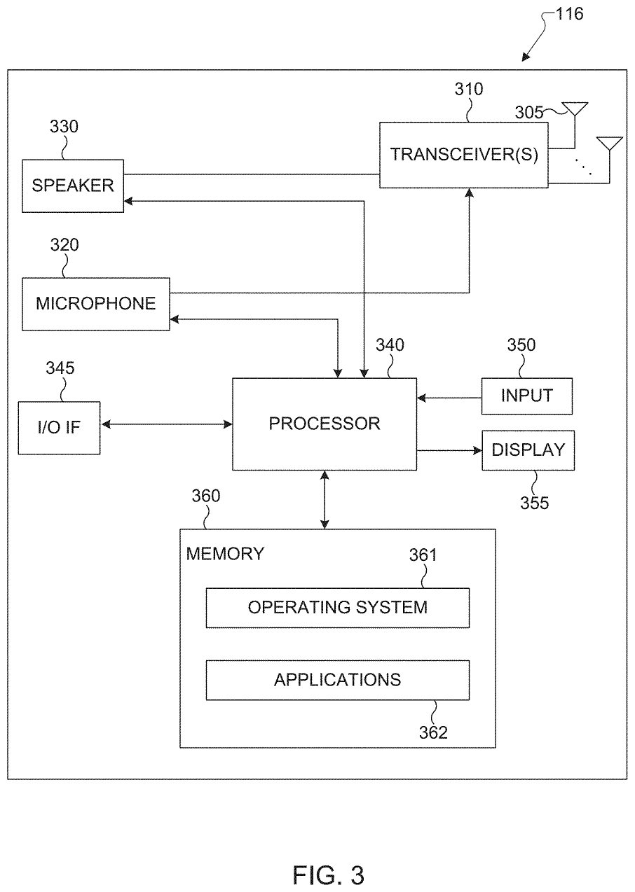

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a reporting with multiple transmission and reception points in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

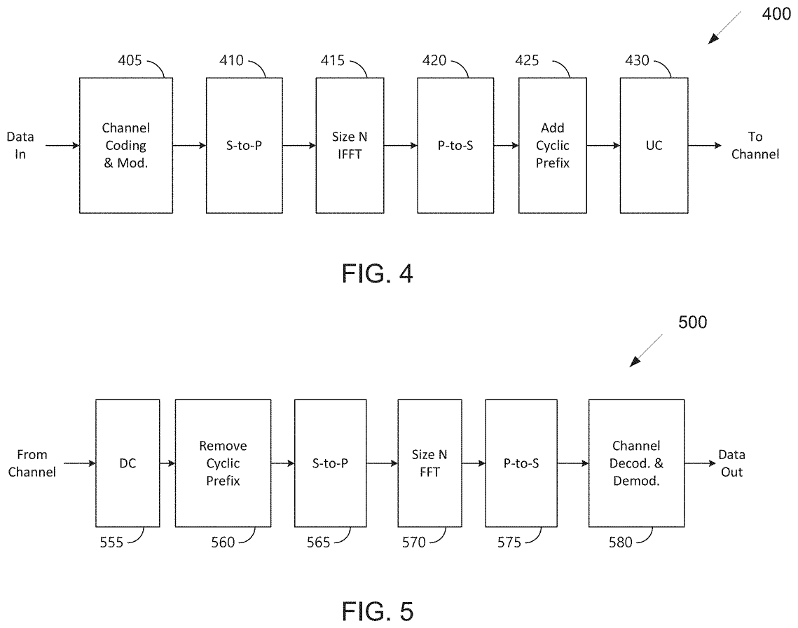

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship or spatial relation between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

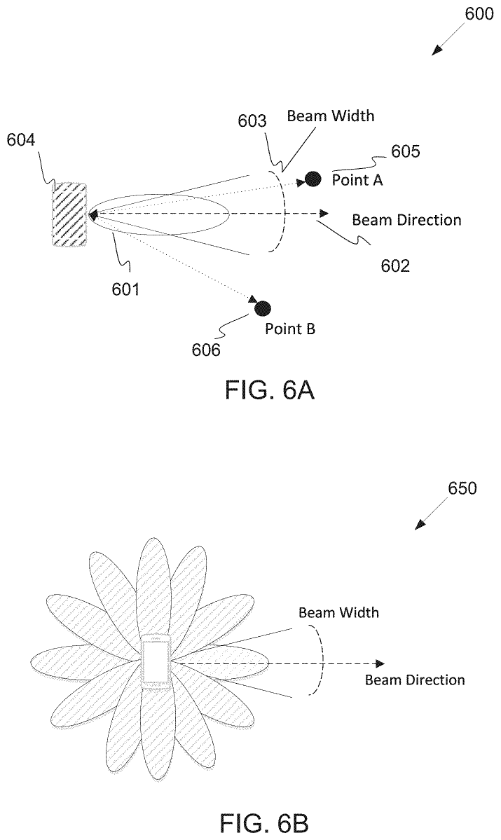

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

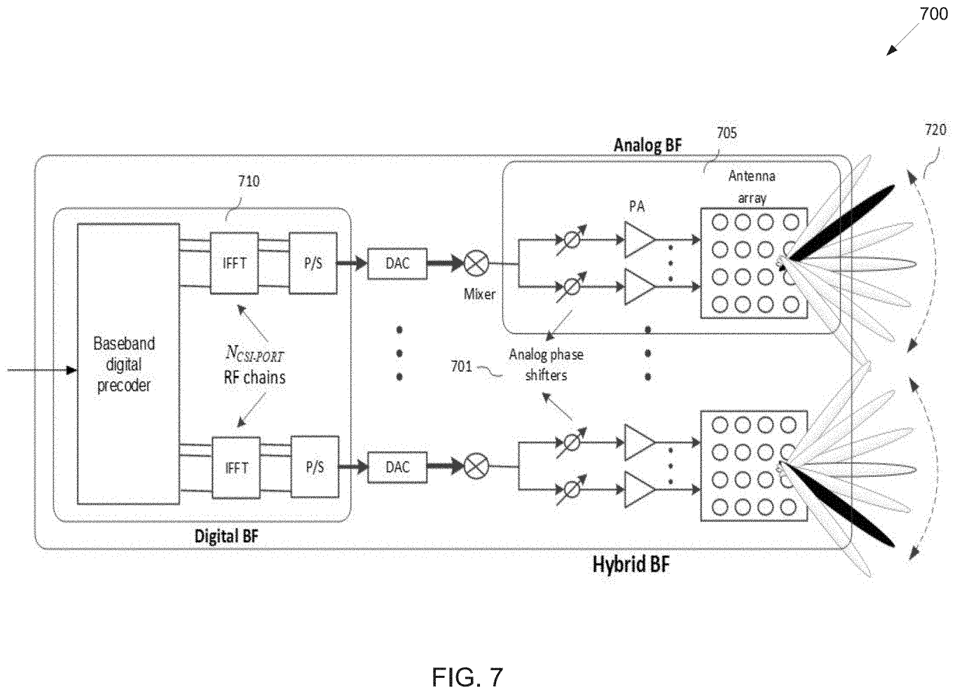

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100m distance), larger number of and sharper analog beams (hence larger number of radiators in the array) may be needed to compensate for the additional path loss.

A time unit for DL signaling, for UL signaling, on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems.

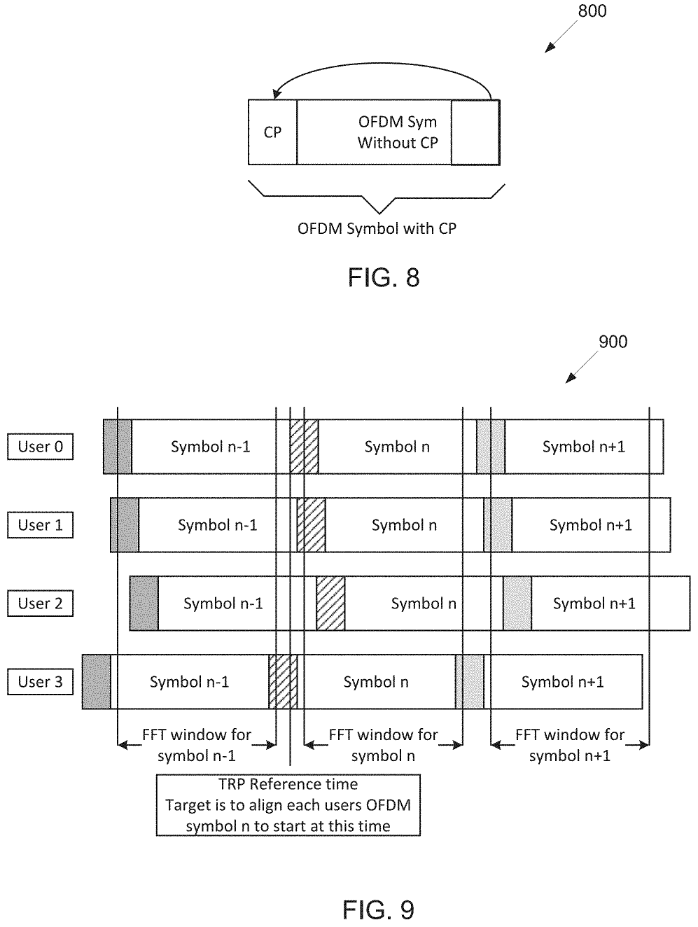

NR uses CP-OFDM and DTF-s-OFDM waveforms for uplink transmissions, i.e., for PUSCH and PUCCH. Both waveforms include a cyclic prefix (CP) appended to the front of each symbol as illustrated in FIG. 8. The CP is the last few samples of the OFDM symbol appended to the front of the symbol. The base station estimates the round-trip-time between the UE and the base station, for example this can be initially estimated using the PRACH channel during random access, the base station signals a timing advance (TA) command to advance the UE's uplink transmission time by a duration equivalent e.g., to the round-trip-delay such that an uplink transmission from the UE and n-TimingAdvanceOffset, e.g., PUSCH or PUCCH arrives aligned to the base station reference timing as illustrated in FIG. 9.

FIG. 8 illustrates an example of OFDM symbol 800 according to embodiments of the present disclosure. The embodiment of the OFDM symbol 800 illustrated in FIG. 8 is for illustration only.

FIG. 9 illustrates an example of FFT window 900 according to embodiments of the present disclosure. The embodiment of the FFT window 900 illustrated in FIG. 9 is for illustration only.

All users are synchronized to the same reference time; this retains orthogonality between users. In FIG. 9, user 0 start time for symbol n, for example symbol n can correspond to symbol zero of a radio frame, is exactly aligned to the reference time of the base station. For user 1, the start time of symbol n is slightly delayed from the base station's reference time. For user 2, the start time of symbol n is delayed even more from the base station's reference time this can be for example due to a time alignment error. For user 3, the start time of symbol n is advanced by a large duration from the base station's reference time, this can for example due to a time alignment error.

The first stage of a NR baseband receiver is the removal of the CP followed by a FFT operator that converts the OFDM symbol from time domain to frequency domain. An example of the FFT window is illustrated in FIG. 9. In this example the FFT window of symbol n starts CP/2 after the base station's reference time, where CP is the duration of the cyclic prefix, the duration of the FFT window is large enough to include all the samples required for FFT operation. Note that in this example, as the FFT window is starting halfway through the CP rather than at the end of the CP, a time adjustment of CP/2 can be done in frequency domain (after the FFT) to compensate the CP/2 offset. If the user's misalignment is within the CP range, i.e., in the range of [−CP/2, CP/2] for the example illustrated in FIG. 9, the signal of user i is cyclically delayed by τᵢ, as long as τᵢ is within the CP range.

For example, user 1 is delayed by τ₁<CP/2, hence within the FFT window of symbol n all the samples belong to symbol n, there is no inter-symbol interference in this case. The delay τᵢ when within the CP range is converted into a phasor after the FFT and can be easily estimated and compensated. If τᵢ is greater than the CP range, inter symbol interference can occur, as illustrate in FIG. 9 for users 2 and 3. For user 2, τ₂ exceeds CP2/, hence in the FFT window of symbol n, there are samples from symbol n−1 leading to inter-symbol interference and thus degrading performance. For user 3, τ₃ is less than −CP2/, hence in the FFT window of symbol n, there are samples from symbol n+1 leading to inter-symbol interference and thus degrading performance.

When a UE is communicating with multiple TRPs, the distances between the UE and each TRP can be different. If the UE were to use a common UL transmission time for transmitting to all TRPs, the UE reception may be aligned to the receive reference time of one TRP, but misaligned (by more than a CP or CP/2) to receive reference time of the other TRPs leading to inter-symbol interference and loss of orthogonality at the other TRPs. One way to avoid this issue is to allow for multiple UL transmit times from the UE wherein each transmit time corresponds to a TRP.

In this disclosure, a beam is determined by either of: (1) a TCI state, that establishes a quasi-colocation (QCL) relationship or a spatial relation association between a source reference signal (e.g., SSB and/or CSI-RS) and a target reference signal; or (2) a spatial relation information that establishes a spatial relation association to a source reference signal, such as SSB or CSI-RS or SRS. In either case, the ID of the source reference signal identifies the beam.

The TCI state and/or the spatial relation reference RS can determine a spatial Rx filter and quasi-colocation information for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

Rel-17 introduced the unified TCI framework, where a unified or master or main or indicated TCI state is signaled to the UE also referred to as an indicated TCI state. The unified or master or main or indicated TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state that can be used at least for UE-dedicated DL channels; or (3) in case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH and CSI-RS, wherein the TCI state provides a reference signal for the quasi co-location for DM-RS of PDSCH and DM-RS of PDCCH in a CC and CSI-RS when following the unified TCI state. The unified (master or main or indicated) TCI state is TCI state of UE-dedicated transmission on dynamic-grant/configured-grant based PUSCH and all of PUCCH resources and SRS, wherein the TCI state provides UL TX spatial filter for dynamic-grant and configured-grant based PUSCH and PUCCH resource in a CC, and SRS when following the unified TCI state.

The unified TCI framework applies to intra-cell beam management, wherein, the TCI states have a source RS that is directly or indirectly associated, through a quasi-co-location relation, e.g., spatial relation, with an SSB of a serving cell. The unified TCI state framework also applies to inter-cell beam management, wherein a TCI state can have a source RS that is directly or indirectly associated, through a quasi-co-location relation, e.g., spatial relation, with an SSB of cell that has a PCI different from the PCI of the serving cell.

A quasi-co-location (QCL) relation, can be quasi-location with respect to one or more of the following relations as illustrated in 3GPP standard specification 38.214: (1) Type A, {Doppler shift, Doppler spread, average delay, delay spread}; (2) Type B, {Doppler shift, Doppler spread}; (3) Type C, {Doppler shift, average delay}; or (4) Type D, {Spatial Rx parameter}.

A UL or joint TCI state can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channel, CSI-RS and sounding reference signal (SRS).

NR supports four different sequence length for random access preamble sequence: (1) sequence length 839 used with sub-carrier spacings 1.25 kHz and 5 kHz with unrestricted or restricted sets; (2) sequence length 139 used with sub-carrier spacings 15 kHz, 30 kHz, 60 kHz and 120 kHz with unrestricted sets; (3) sequence length 571 used with sub-carrier spacing 30 kHz with unrestricted sets; and (4) sequence length 1151 used with sub-carrier spacing 15 kHz with unrestricted sets.

RACH preambles are transmitted in PRACH Occasions (ROs). Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one time instance. This is provided by higher layer parameter msg1-FDM. The time instances of the PRACH Occasions are determined by the higher layer parameter prach-ConfigurationIndex, and Tables as illustrated in TS 38.211.

SSBs are associated with ROs. The number of SSBs associated with one RO can be provided by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB. SS/PBCH block indexes provided by ssb-PositionsInBurst in SIB1 or in ServingCellConfigCommon are mapped to valid PRACH occasions in the following order as illustrated in 3GPP standard specification 38.213: (1) first, in increasing order of preamble indexes within a single PRACH occasion; (2) second, in increasing order of frequency resource indexes for frequency multiplexed PRACH occasions; (3) third, in increasing order of time resource indexes for time multiplexed PRACH occasions within a PRACH slot; or (4) fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, type-1 random access procedure and type-2 random access procedure.

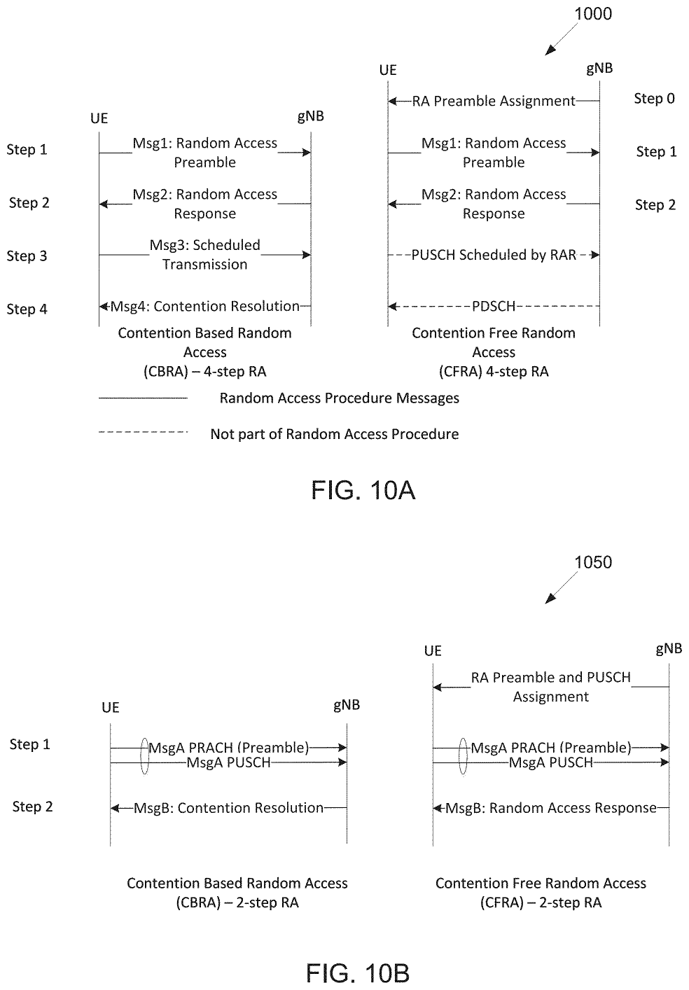

FIG. 10A illustrates an example of type-1 random access procedure 1000 according to embodiments of the present disclosure, as may be performed by a UE (e.g., 111-116 as illustrated in FIG. 1) and a base station (e.g., 101-103 as illustrated in FIG. 1). An embodiment of the type-1 random access procedure 1000 shown in FIG. 10A is for illustration only. One or more of the components illustrated in FIG. 10A can be implemented in specialized circuitry configured to perform the noted functions or one or more of the components can be implemented by one or more processors executing instructions to perform the noted functions.

Type-1 random access procedure also known as four-step random access procedure (4-step RACH), is as illustrated in FIG. 10A: (1) in step 1, the UE transmits a random access preamble, also known as Msg1, to the gNB. The gNB attempts to receive and detect the preamble; (2) in step 2, the gNB upon receiving the preamble transmits a random access response (RAR), also known as Msg2, to the UE including, among other fields, a timing adjustment or timing advance (TA) command and an uplink grant for a subsequent PUSCH transmission; (3) in step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC reconfiguration complete message; and (4) in step 4, the gNB upon receiving the RRC reconfiguration complete message, allocates downlink and uplink resources that are transmitted in a downlink PDSCH transmission to the UE.

After the last step, the UE can proceed with reception and transmission of data traffic. Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

FIG. 10 illustrates an example of type-2 random access procedure 1050 according to embodiments of the present disclosure, as may be performed by a UE (e.g., 111-116 as illustrated in FIG. 1) and a base station (e.g., 101-103 as illustrated in FIG. 1). An embodiment of the type-2 random access procedure 1050 shown in FIG. 10B is for illustration only. One or more of the components illustrated in FIG. 10B can be implemented in specialized circuitry configured to perform the noted functions or one or more of the components can be implemented by one or more processors executing instructions to perform the noted functions.

Release 16, introduced a new random access procedure; Type-2 random access procedure, also known as 2-step random access procedure (2-step RACH), is as illustrated in FIG. 10B, that combines the preamble and PUSCH transmission into a single transmission step from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered by a PDCCH order. The PDCCH order is triggered by DCI Format 1_0 with CRC scrambled by C-RNTI and the “frequency domain resource assignment” field is set to all ones. The fields of DCI format 1_0 carrying the PDCCH order are interrupted as shown in TABLE 1.

TABLE 1

| Field | Size | Description |
|---|---|---|
| Identifier for DCI | 1 | The value of this bit field is |
| formats | | always set to 1, indicating a DL |
| | | DCI format |
| Frequency domain | [1og₂ (N^{DL,BWP}_{RB}(N^{DL,BWP}_{RB} + | Set to all ones |
| resource | 1)/2)] | |
| assignment | | |
| Random Access | 6 bits | |
| Preamble index | | |
| UL/SUL indicator | 1 bit | |
| SS/PBCH index | 6 bits | If “Random Access Preamble |
| | | index” is not zero indicates SSB |
| | | index of RO used, else this field |
| | | is reserved |
| PRACH Mask | 4 bits | If “Random Access Preamble |
| index | | index” is not zero indicates RO |
| | | used, else this field is reserved |
| Reserved bits | 12 bits or 10 bits | |

If “Random Access Preamble index” is not zero, the PDCCH order triggers a contention free random access preamble, wherein the PRACH Occasion is determined based on the “SS/PBCH index” indicated in the PDCCH order and the “PRACH Mask index” indicated in the PRACH Occasion associated with the SS/PBCH indicated by “SS/PBCH index.” The “Random Access Preamble index” indicates the preamble index to use in the PRACH Occasion.

If a PRACH transmission from a UE is in response to a detection of a PDCCH order by the UE that triggers a contention-free random access procedure, the preamble can be transmitted based on the SSB that the DL RS that the DM-RS of the PDCCH order is quasi-collocated with.

If the UE attempts to detect the DCI format 1_0 with CRC scrambled by the corresponding RA-RNTI in response to a PRACH transmission initiated by a PDCCH order that triggers a contention-free random access procedure for the SpCell as illustrated in TS 38.321, the UE may assume that the PDCCH that includes the DCI format 1_0 and the PDCCH order have same DM-RS antenna port quasi co-location properties. When receiving a PDSCH scheduled with RA-RNTI in response to a random access procedure triggered by a PDCCH order which triggers contention-free random access procedure for the SpCell as illustrated in TS 38.321, the UE may assume that the DM-RS port of the received PDCCH order and the DM-RS ports of the corresponding PDSCH scheduled with RA-RNTI are quasi co-located with the same SS/PBCH block or CSI-RS with respect to Doppler shift, Doppler spread, average delay, delay spread, spatial RX parameters when applicable.

If the UE attempts to detect the DCI format 1_0 with CRC scrambled by the corresponding RA-RNTI in response to a PRACH transmission initiated by a PDCCH order that triggers a contention-free random access procedure for a secondary cell, the UE may assume the DM-RS antenna port quasi co-location properties of the CORESET associated with the Type1-PDCCH CSS set for receiving the PDCCH that includes the DCI format 1_0.

If “Random Access Preamble index” is zero, the PDCCH order triggers a contention based random access procedure. If a PRACH transmission from a UE is in response to a detection of a PDCCH order by the UE that triggers a contention-based random access procedure, the UE can determine a SSB for the preamble transmission and select a preamble in a PRACH occasion corresponding to the SSB. If the UE attempts to detect the DCI format 1_0 with CRC scrambled by the corresponding RA-RNTI in response to a PRACH transmission initiated by a PDCCH order that triggers a contention-based random access procedure, the UE may assume same DM-RS antenna port quasi co-location properties for PDCCH and PDSCH, as for a SS/PBCH block or a CSI-RS resource the UE used for PRACH association.

The present disclosure provides schemes to ensure that the alignment of UL transmission timing when communicating across beams with different round trip propagation delays (different round trip times (RTTs)). As well methods to handle overlap of UL transmissions at the UE due to different TA values.

A UE may be communicating with the network through two or more spatial relation filters for transmission and receptions, which in this disclosure are referred to as beams. The beams are determined by a TCI state, for example, a joint TCI state for UL and DL beams, or a DL TCI state for DL beams or a UL TCI state UL beams. The beams can be associated with a single TRP, alternatively, the beams can be associated with multiple (two or more) TRPs, wherein the TRPs can have a same physical cell identity (PCI) (i.e., transmitting SSBs associated with the same PCI), or can have different PCIs (i.e., transmitting SSBs associated with different PCIs). The round trip propagation delay, or round trip propagation time (RTT) on each beam can be different. For example, this can be due to different propagation paths due to different reflections and/or due to different distances between the UE and the TRPs.

As described earlier, the UL signal from the UE may arrive at each TRP at its reference time, as a result the transmission on each beam (e.g., to a corresponding TRP) may have a different transmission time, and hence a different TA value to arrive at the corresponding TRP at that TRP's reference time. The present disclosure provides for measuring the time difference between different beams. The present disclosure provide the signaling, application and determination of TAs for different beams with different RTTs.

Embodiments in this disclosure considers design aspects related to: (1) measuring and reporting “DL delta propagation delay” between reference signals; (2) triggering random access procedure for measuring TA; and (3) handling overlap of UL transmissions at the UE due to different TA values. The embodiments in this disclosure provides for determination of TAs for different beams with different RTTs.

In the following, both FDD and TDD are considered as a duplex method for DL and UL signaling. Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

This disclosure considers several components that can be used in conjunction or in combination with one another, or can operate as standalone schemes.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” corresponds to a set of characteristics of a DL beam or an UL TX beam, such as a direction, a precoding/beamforming, a number of ports, and so on.

In the following components, a TCI state is used for beam indication. It can refer to a DL TCI state for downlink channels (e.g., PDCCH and PDSCH) or downlink signals (e.g., CSI-RS), an uplink TCI state for uplink channels (e.g., PUSCH or PUCCH) or uplink signals (e.g., SRS), a joint TCI state for downlink and uplink channels or signals, or separate TCI states for uplink and downlink channels or signals. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

In the examples of this disclosure, a UE can communicate with the network using different beams for example associated with TRPs. The different beams can be used at different times (e.g., switching from one beam to another beam), or can be used simultaneously, (e.g., simultaneously receiving from network on multiple beams or simultaneously transmitting to the network on multiple beams).

In one example, the UE communicates to the same TRP on two or more different beams. The different beams have different round trip delays. For example, the different round trip delays can be due to different reflections.

In another example, the UE communicates with two or more different TRPs with same physical cell identity (PCI). The UE uses at least one beam to communicate with each TRP. The round delay to each TRP can be different. The TRPs can be synchronized or unsynchronized. This is an example of intra-cell multi-TA (e.g., 2 TA in case of 2 TRPs).

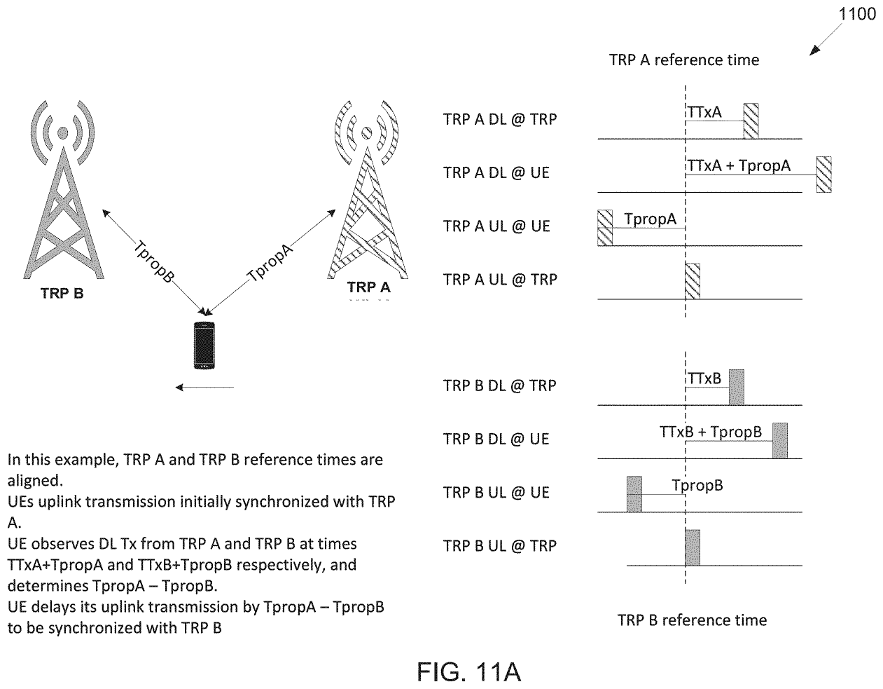

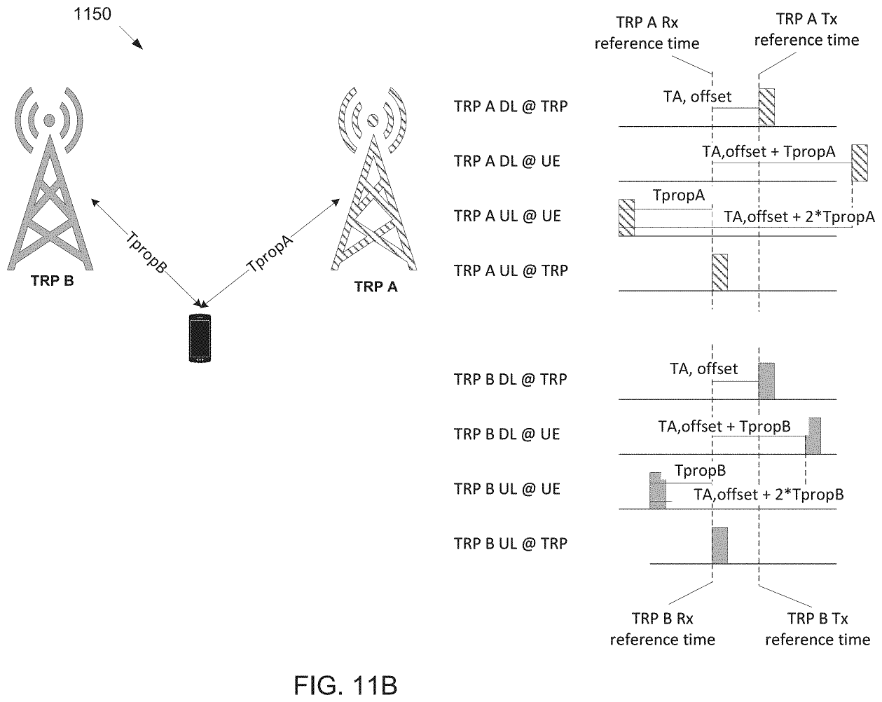

FIG. 11A illustrates an example of UE communication with TRP A and TRP B 1100 according to embodiments of the present disclosure. The embodiment of the UE communication with TRP A and TRP B 1100 illustrated in FIG. 11A is for illustration only.

FIG. 11B illustrates an example of UE communication with TRP A and TRP B 1150 according to embodiments of the present disclosure. The embodiment of the UE communication with TRP A and TRP B 1150 illustrated in FIG. 11B is for illustration only.

FIG. 11A illustrates an example of a UE communicating with a first TRP, TRP A, and a second TRP, TRP B. When communicating with TRP A, the uplink PUSCH transmission is synchronized such that it arrives at TRP A at its reference time, within the CP range as described previously.

FIG. 11B illustrates a further example of a UE communicating with a first TRP, TRP A, and a second TRP, TRPB. At each TRP the DL transmissions are synchronized at transmission (Tx) reference time and the UL receptions are synchronized to receive reference time. The difference between Tx reference time and the Rx reference time is TA,offset. For example, TA,offset can correspond to the time in units of time (μs, ms or sec) of n-TimingAdvanceOffset (N_{TA,offset}), wherein N_{TA,offset} can be in units of T_{c}, wherein T_{c}=1/(Δfₘₐₓ·N_{f}), where Δfₘₐₓ=480 kHz. In one example N_{TA,offset}=0. In one example N_{TA,offset}=25600. In one example N_{TA,offset}=39936. In one example, N_{TA,offset}=13792.

In FIG. 11B, the gNB transmits the DL signal at the TRP's Tx reference time, which can be after the TRP's Rx reference by TA,offset. The DL signal undergoes a DL propagation delay of Tprop, wherein Tprop is the one-way propagation delay between the UE and the TRP. The DL signal arrives at the UE, at Tprop after the TRP's Tx reference time, or at TA,offset+Tprop after the TRP's Rx reference. The UE advances the UL transmission time relative to the DL reception time by TA,offset+round-trip-time (RTT), wherein the round-trip-time is the sum of the DL propagation delay and UL propagation delay which is 2*Tprop. Hence the UL transmission at the UE is TA,offset+Tprop before the TRP's Tx reference time or Tprop before the TRP's Rx reference time. The UL transmission undergoes an UL propagation delay of Tprop, wherein Tprop is the one-way propagation delay between the UE and the TRP. The UL reception at the base station arrives at the TRP's Rx reference time, or TA,offset before the TRP's Tx reference time.

As described above, the UE advances the UL transmission time relative to the DL reception time by TA,offset+round-trip-time (RTT) which can be expressed by T_{TA}=(N_{TA}+N_{TA,offset})·T_{c} as illustrated in TS 38.211.

In one example, N_{TA} can be indicated in the random access response (RAR) of a Type 1 random access procedure or MSGB response of a Type 2 random access procedure. In which case, the timing advance command can signal an absolute value, T_{A}, which is 12-bits:

$${N}_{TA} = \frac{{T}_{A} \cdot 16 \cdot 64}{{2}^{μ}} ,$$

wherein, μ is the sub-carrier spacing configuration.

In one example, the change in value of N_{TA} can be indicated in a Timing Advance MAC CE command as illustrated in TS 38.321. For example, the Timing Advance MAC CE indicates a T_{A} values in the range of 0, 1, . . . , 63 (e.g., a 6-bit value). The updated (new) N_{TA} value relative to the previous (old) N_{TA} value is given by:

$${N}_{TA , new} = {N}_{TA , old} + \frac{( {T}_{A} - 31 ) \cdot 16 \cdot 64}{{2}^{μ}} ,$$

wherein, μ is the sub-carrier spacing configuration.

In one example, N_{TA} can be indicated in an absolute timing advance MAC CE command. In which case, the timing advance command can signal an absolute value, T_{A}, which is 12-bits:

$${N}_{TA} = \frac{{T}_{A} \cdot 16 \cdot 64}{{2}^{μ}} ,$$

wherein, μ is the sub-carrier spacing configuration.

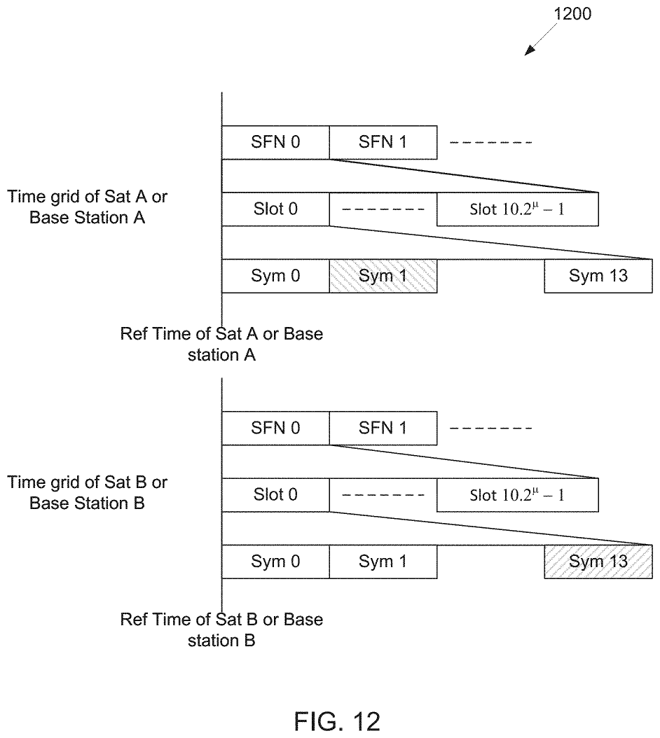

In one example, TRP A and TRP B are synchronized such that TRP A has the same reference time as TRP B as illustrated in FIG. 11A. For example, the reference time within each TRP can be the start of system frame number 0 (SFN 0) as shown in FIG. 12.

FIG. 12 illustrates an example of symbol and slot 1200 according to embodiments of the present disclosure. The embodiment of the symbol and slot 1200 illustrated in FIG. 12 is for illustration only.

The TRP establishes its time grid which determines the transmission time of each SFN, each slot within the SFN and each symbol within each slot within each SFN relative to this reference time. In FIG. 11A and in FIG. 12, the reference time of TRP A is the same as the reference time of TRP B. In FIG. 12, y is the Sub-Carrier Spacing Configuration, which determines the sub-carrier spacing (SCS). For example, μ=0 is for SCS 15 kHz, μ=1 is for SCS=30 kHz, . . . in general for SCS configuration μ the SCS is 2^{μ}·15 kHz. TRP A transmits a downlink signal at time T_{TxA} relative to its reference time. In the example of FIG. 12, the reference signal from TRP A is in Symbol 1 of Slot 0 of SFN 0, in this case, T_{TxA} is the start of Symbol 1 of Slot 0 of SFN 0. For example, the reference signal can be an SS/PBCH block.

In another example, the reference signal can be a NZP CSI-RS. In another example, the reference signal can be PDCCH DM-RS or PDSCH DM-RS. The signal from TRPA undergoes a propagation delay T_{PropA}. The signal is received at the UE at a time (relative to the reference time): T_{DL_UE_A}=T_{TxA}+T_{PropA}. TRP B transmits a downlink signal at time T_{TxB} relative to its reference time.

In FIG. 12, the reference signal from TRP B is in Symbol 13 of Slot 0 of SFN 0, in this case, T_{TxB} is the start of Symbol 13 of Slot 0 of SFN 0. For example, the reference signal can be an SS/PBCH block. In another example, the reference signal can be a NZP CSI-RS. In another example, the reference signal can be PDCCH DM-RS or PDSCH DM-RS. The signal from TRP B undergoes a propagation delay T_{PropB}. The signal is received at the UE at time (relative to the reference time): T_{DL_UE_B}=T_{TxB}+T_{PropB}.

The UE can determine the difference in propagation delay from the two TRPs, i.e.: T_{PropA}−T_{PropB}=(T_{DL_UE_A}−T_{TxA})−(T_{DL_UE_B}−T_{TxB}).

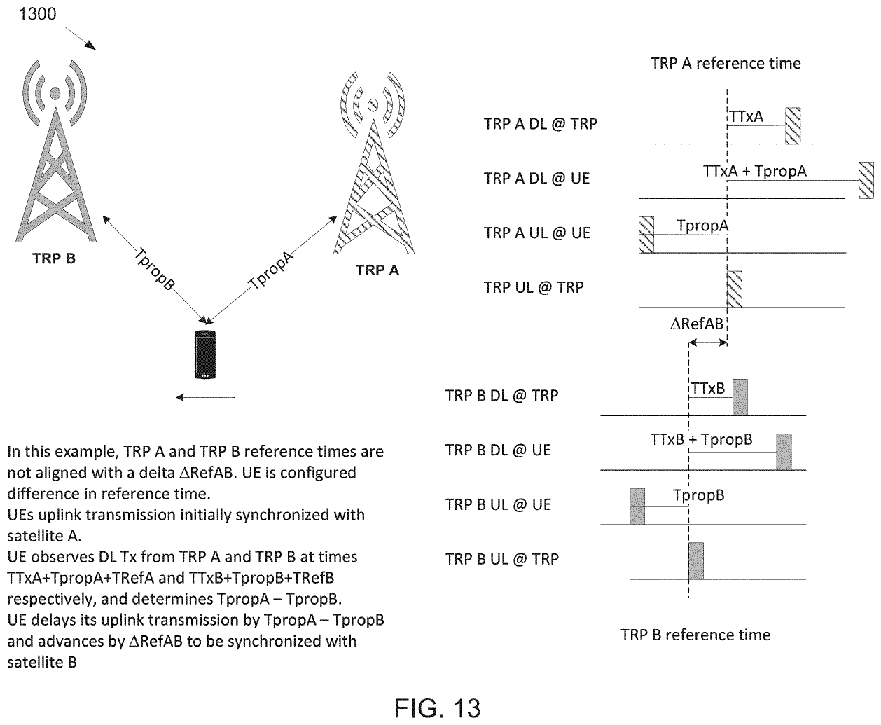

FIG. 13 illustrates an example of UE communication with TRP A and TRP B 1300 according to embodiments of the present disclosure. The embodiment of the UE communication with TRP A and TRP B 1300 illustrated in FIG. 13 is for illustration only.

In another example, TRP A and TRP B have different reference times as illustrated in FIG. 13. A variant of FIG. 13 is to have a different reference time for DL transmit and UL receive for each TRP similar to the illustration in FIG. 111B. Let TRP A's reference time be T_{RefA} and TRP B's reference time be T_{RefB}, the difference in reference time is: Δ_{RefAB}=T_{RefA}−T_{RefB}.

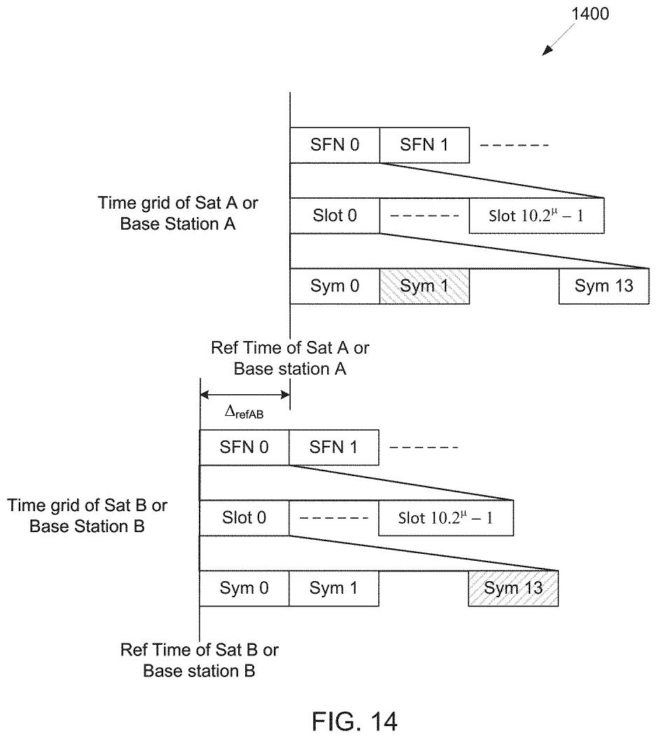

FIG. 14 illustrates an example of symbol and slot 1400 according to embodiments of the present disclosure. The embodiment of the symbol and slot 1400 illustrated in FIG. 14 is for illustration only.

For example, the reference time within each TRP can be the start of System Frame Number 0 (SFN 0) as shown in FIG. 14. The TRP establishes its time grid which determines the transmission time of each SFN, each slot within the SFN and each symbol within each slot within each SFN relative to this reference time. In FIG. 14, the reference time of TRP A is after the reference time of TRP B by Δ_{RefAB}. In FIG. 14, μ is the Sub-Carrier Spacing Configuration, which determines the sub-carrier spacing (SCS). For example, μ=0 is for SCS 15 kHz, μ=1 is for SCS=30 kHz, . . . in general for SCS configuration μ the SCS is 2^{μ}·15 kHz.

TRP A transmits a downlink signal at time T_{TxA} relative to its reference time. In the example of FIG. 12, the reference signal from TRP A is in Symbol 1 of Slot 0 of SFN 0, in this case, T_{TxA} is the start of Symbol 1 of Slot 0 of SFN 0. For example, the reference signal can be an SS/PBCH block. In another example, the reference signal can be a CSI-RS. In another example, the reference signal can be PDCCH DM-RS or PDSCH DM-RS. The signal from TRP A undergoes a propagation delay T_{PropA}. The signal is received at the UE at time: T_{DL_UE_A}=T_{RefA}+T_{TxA}+T_{PropA}.

TRP B transmits a downlink signal at time T_{TxB} relative to its reference time. In the example of FIG. 14, the reference signal from TRP B is in Symbol 13 of Slot 0 of SFN 0, in this case, T_{T}xB is the start of Symbol 13 of Slot 0 of SFN 0. For example, the reference signal can be an SS/PBCH block. In another example, the reference signal can be a CSI-RS. In another example, the reference signal can be PDCCH DM-RS or PDSCH DM-RS. The signal from TRP B undergoes a propagation delay T_{PropB}. The signal is received at the UE at time: T_{DL_UE_B}=T_{RefB}+T_{TxB}+T_{PropB}.

The UE can determine the difference in propagation delay with the two TRPs, i.e.:

$${T}_{PropA} - {T}_{PropB} = ( {T}_{DL \_ UE \_ A} - {T}_{TxA} - {T}_{RefA} ) - ( {T}_{DL \_ UE \_ B} - {T}_{TxB} - {T}_{RefB} ) = ( {T}_{DL \_ UE \_ A} - {T}_{TxA} ) - ( {T}_{DL \_ UE \_ B} - {T}_{TxB} ) - {Δ}_{RefAB}$$

In another example, the UE communicates with two or more different TRPs with same or different physical cell identity (PCI). The UE uses at least one beam to communicate with each TRP. The round delay to each TRP can be different. The TRPs can be synchronized or unsynchronized. When at least one of the TRPs has a different PCI from the other TRP(s), this is an example of inter-cell multi-TA (e.g., 2 TA in case of 2 TRPs).

In this disclosure, a TA group or TA_grp can refer to a TAG, for example there can be more than one TAG and each TAG can have one TA value. A TA group or TA_grp can also refer a TA index within a TAG, for example, a TAG can have more than one TA value, each associated with a TA index.

A UE is configured or determines a first DL reference signal, RS1.

A UE is configured or determines a second DL reference signal RS2.

The UE measures the time of arrival of the first reference signal T₁. The UE measures the time of arrival of the second reference signal T₂.

The UE reports to the network the difference in propagation delay (delta DL propagation delay) based on the received RS1 and RS2.

In one example, the reference signals for “delta DL propagation delay” measurement are provided.

In one example, the first DL reference signal can be one of: (1) synchronization signal/physical broadcast channel block (SSB); (2) non-zero power (NZP) channel state information-reference signal (CSI-RS) for tracking (aka tracking reference signal (TRS)); (3) NZP CSI-RS for beam management; (4) NZP CSI-RS for CSI acquisition; (5) DMRS for PDSCH; and (6) DMRS for PDCCH.

The first DL reference signal can additionally be one of: (1) a source reference signal of a TCI state with quasi-co-location (QCL) TypeD; (2) a source reference signal of a TCI state QCL Type A or Type B or Type C; and (3) a reference signal configured for timing measurement.

The network can configure/update the first DL reference signal to be used for timing measurement based on the above, using RRC configuration and/or MAC CE signaling and/or L1 control (e.g., DCI) signaling.

In a further example, there is no configuration of the first reference signal, any DL reference signal configured as QCL Type D source RS can be used for timing measurement.

In a further example, there is no configuration of the first reference signal, any DL reference signal configured as QCL Type D source RS for an activated TCI state can be used for timing measurement.

In a further example, there is no configuration of the first reference signal, any DL reference signal configured as QCL Type D source RS for an indicated TCI state can be used for timing measurement.

In another example, the second DL reference signal can be one of: (1) synchronization signal/physical broadcast channel block (SSB); (2) Non-zero power (NZP) channel state information-reference signal (CSI-RS) for tracking (aka tracking reference signal (TRS)); (3) NZP CSI-RS for beam management; (4) NZP CSI-RS for CSI acquisition; (5) DMRS for PDSCH; and (6) DMRS for PDCCH.

The second DL reference signal can additionally be one of: (1) a source reference signal of a TCI state with quasi-co-location (QCL) TypeD; (2) a source reference signal of a TCI state QCL Type A or Type B or Type C; (3) a reference signal configured for additionalPCI; or (4) a reference signal configured for timing measurement.

The network can configure/update the second DL reference signal to be used for timing measurement based on the above, using RRC configuration and/or MAC CE signaling and/or L1 control (e.g., DCI) signaling.

In a further example, there is no configuration of the second reference signal, any DL reference signal configured as QCL Type D source RS can be used for timing measurement.

In a further example, there is no configuration of the second reference signal, any DL reference signal configured as QCL Type D source RS for an activated TCI state can be used for timing measurement.

In a further example, there is no configuration of the second reference signal, any DL reference signal configured as QCL Type D source RS for an indicated TCI state can be used for timing measurement.

In one example, the configuration of the “delta DL propagation delay” measurement is provided.

In one example, the UE is configured a set of DL reference signals, e.g., S={RS₀, RS₁, . . . }, the UE is configured to measure the “delta DL propagation delay” between each two RS (e.g., RSᵢ and RSⱼ) such that RSᵢ∈S, RSⱼ ∈S and i≠j.

In one example, the UE is configured a first DL reference signal to use as the reference for “delta DL propagation delay” measurements (e.g., RS1). The UE is further configured a set of second DL reference signals, e.g., S2={RS2₀, RS2₁, . . . }, the UE measures the “delta DL propagation delay” between RS1 and each RS2ᵢ such that RS2ᵢ ∈S2.

In one example, the UE is configured time advance groups and an association between reference signals and time advance groups. For example, (1) TA Grp_0, includes reference signals in set S0={RS0₀, RS0₁, . . . }, (2) TA Grp_1, includes reference signals in set S1={RS1₀, RS1₁, . . . } . . . . TA Grp_n.

For example, a TA group can be associated with an entity, wherein the entity index can be: (1) TRP index; (2) PCI; (3) CORESETPOOLindex; (4) SSB index; and (5) TA group index.

The UE measures “delta DL propagation delay” between TA Grp_i and TA Grp_j such that i #j.

In one example, the “DL delta propagation delay” between TA Grp_i and TA Grp_j is the “DL delta propagation delay” between any RS in set Si and any RS in set Sj. It is up to the UE's implementation to select the RS within each set.

In one example, the “DL delta propagation delay” between TA Grp_i and TA Grp_j is the “DL delta propagation delay” between an RS in set Si and an RS in set Sj, wherein the RS to select from each set is configured/updated by RRC signaling and/or MAC CE signaling and/or L1 control signaling.

In one example, the “DL delta propagation delay” between TA Grp_i and TA Grp_j is the average “DL delta propagation delay” between each RS in set Si and each RS in set Sj.

In one example, the UE determines the average time of arrival for RSes in Si for TA Grp_i, and the RSes in Sj for TA Grp_j and calculates the “DL delta propagation delay” between TA Grp_i and TA Grp_j based on the average time of arrivals of each group.

In one example, UE measures the time of arrival of the first-in-time received or detected RS in Si for TA Grp_i and the UE measures the time of arrival of the first-in-time received or detected RS in Sj for TA Grp_j and calculates the “DL delta propagation delay” between TA Grp_i and TA Grp_j based on the first-in-time received or detected RS of each group. In one example the RSes can be SSBs. In one example the RSes can be CSI-RS resources. In one example the RSes can be SSBs or CSI-RS resources.

In one example, a UE measures the time of arrival of the first-in-time received or detected RS that exceeds an RSRP threshold in Si for TA Grp_i and the UE measures the time of arrival of the first-in-time received or detected RS that exceeds an RSRP threshold in Sj for TA Grp_j and calculates the “DL delta propagation delay” between TA Grp_i and TA Grp_j based on the first-in-time received or detected RS that exceeds the RSRP threshold of each group. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling.

In one example, a UE measures the time of arrival of the last-in-time received or detected RS in Si for TA Grp_i and the UE measures the time of arrival of the last-in-time received or detected RS in Sj for TA Grp_j and calculates the “DL delta propagation delay” between TA Grp_i and TA Grp_j based on the last-in-time received or detected RS of each group. In one example the RSes can be SSBs. In one example the RSes can be CSI-RS resources. In one example the RSes can be SSBs or CSI-RS resources.

In one example, a UE measures the time of arrival of the last-in-time received or detected RS that exceeds an RSRP threshold in Si for TA Grp_i and the UE measures the time of arrival of the last-in-time received or detected RS that exceeds an RSRP threshold in Sj for TA Grp_j and calculates the “DL delta propagation delay” between TA Grp_i and TA Grp_j based on the last-in-time received or detected RS that exceeds the RSRP threshold of each group. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling.

In one example, a UE measures the time of arrival of the strongest (e.g., largest RSRP or largest SINR or best signal quality) received or detected RS in Si for TA Grp_i and the UE measures the time of arrival of the strongest (e.g., largest RSRP or largest SINR or best signal quality) received or detected RS in Sj for TA Grp_j and calculates the “DL delta propagation delay” between TA Grp_i and TA Grp_j based on the strongest (e.g., largest RSRP or largest SINR or best signal quality) received or detected RS of each group. In one example the RSes can be SSBs. In one example the RSes can be CSI-RS resources. In one example the RSes can be SSBs or CSI-RS resources.

In one example, the “DL delta propagation delay” between TA Grp_i and TA Grp_j is the “DL delta propagation delay” between any RS in set Si and an RS in set Sj. It is up to the UE's implementation to select the RS within Si, and the RS from Sj is configured/updated by RRC signaling and/or MAC CE signaling and/or L1 control signaling. The role of i and j can be reversed.

In one example, the “DL delta propagation delay” between TA Grp_i and TA Grp_j is the average “DL delta propagation delay” between any RS in set Si and each RS in set Sj. It is up to the UE's implementation to select the RS within Si. Alternatively, the UE can determine an average time of arrive for RSes in Si for TA Grp_i, and use that to determine the “DL delta propagation delay.” The role of i and j can be reversed.

In one example, the “DL delta propagation delay” between TA Grp_i and TA Grp_j is the average “DL delta propagation delay” between an RS in set Si and each RS in set Sj. The RS from Si is configured/updated by RRC signaling and/or MAC CE signaling and/or L1 control signaling. Alternatively, the UE can determine an average time of arrive for RSes in Si for TA Grp_i, and use that to determine the “DL delta propagation delay.” The role of i and j can be reversed.

In one example, a reference group is configured. For example, TA Grp_i is configured by RRC signaling. Alternatively, TA Grp_i can be that with: (1) activated TCI states; and (2) Indicated TCI states.

In one example, the media and content of a “DL delta propagation delay” measurement report is provided.

In one example, the measurement report including the “DL delta propagation delay” measurement between the first DL reference signal and the second downlink reference signal is transmitted in uplink control information (UCI), wherein the UCI is transmitted on PUCCH.

In another example, the measurement report including the “DL delta propagation delay” measurement between the first DL reference signal and the second downlink reference signal is transmitted in uplink control information (UCI), wherein the UCI is transmitted on PUSCH.

In another example, the measurement report including the “DL delta propagation delay” measurement between the first DL reference signal and the second downlink reference signal is transmitted in uplink control information (UCI), wherein the UCI is transmitted on msg3 PUSCH (part of Type 1 random access procedure) or a msgA PUSCH (part of Type 2 random access procedure).

In another example, the measurement report including the “DL delta propagation delay” measurement between the first DL reference signal and the second downlink reference signal is transmitted in medium access control-control element (MAC CE).

In one example, the measurement report includes at least one of: (1) the identity of the second DL reference signal; or (2) the “DL delta propagation delay.”

In this example, the identity of the first DL reference signal to use for “DL delta propagation delay” measurements can be: (1) configured by RRC; (2) configured by MAC CE. For example, the ID of the first (or last) TCI state in the MAC CE activating TCI states; and (3) that of the source RS (e.g., of QCL typeD) of the indicated TCI state. The TCI state can be indicated by DCI or MA CE.

In another example, the measurement report includes at least one of: (1) the identity of the first DL reference signal; (2) the identity of the second DL reference signal; or (3) the “DL delta propagation delay.”

In another example, the measurement report includes at least one of: (1) the identity of a timing advance group (TAG); or (2) the “DL delta propagation delay.”

Wherein, TAGs are configured by RRC. A reference signal can be associated with the TAG-ID.

In examples, the “DL delta propagation delay” can be following example.

In one example, the “DL delta propagation delay” is in units of 16 Tₛ or 16·κT_{c}, wherein Tₛ is as defined in TS 38.211, Tₛ=1/(Δf_{ref}·N_{f,ref}), where Δf_{ref}=15 kHz and N_{f,ref}=2048. T_{c} is as defined in TS 38.211,

$${T}_{c} = 1 / ( Δ {f}_{max} \cdot {N}_{f} ) , \\ where Δ {f}_{max} = 480 kHz and {N}_{f} = 4096 , and κ = \frac{{T}_{s}}{{T}_{c}} = 64.$$

In another example, the “DL delta propagation delay” is in units of 16Tₛ/2^{μ} or 16·κT_{c}/2^{μ}, wherein Tₛ is as defined in TS 38.211, Tₛ=1/(Δf_{ref}·N_{f,ref}), where Δf_{ref}=15 kHz and N_{f,ref}=2048. T_{c} is as defined in TS 38.211,

$${T}_{c} = 1 / ( Δ {f}_{max} \cdot {N}_{f} ) , \\ where Δ {f}_{max} = 480 kHz and {N}_{f} = 4096 , and κ = \frac{{T}_{s}}{{T}_{c}} = 64.$$

μ is the sub-carrier spacing configuration. μ=0 for a 15 kHz sub-carrier spacing. μ=1 for a 30 kHz sub-carrier spacing. μ=2 for a 60 kHz sub-carrier spacing. μ=8 for a 120 kHz sub-carrier spacing.

In one example, the “DL delta propagation delay” is X bits wide. X can be specified in the specifications, for example X=6 bits or X=12 bits or another value as specified in the specifications.

In one example, the “DL delta propagation delay” is limited within a CP. A CP has a duration 144·Tₛ·2^{-μ}. In one example, “DL delta propagation delay” is X bits wide, where X can be:

$$⌈ {log}_{2} ( \frac{144}{16} ) ⌉ = 4 bits .$$

In one example, the “DL delta propagation delay” is limited within a CP. A CP has a duration 512·Tₛ·2^{-μ}. In one example, “DL delta propagation delay” is X bits wide, where X can be one of:

$$⌈ {log}_{2} ( \frac{512}{16} ) ⌉ = 5 bits .$$

In one example, the timing of the “DL delta propagation delay” measurement report is provided.

In one example, the UE is configured a “DL delta propagation delay” threshold Y. If the “DL delta propagation delay” between a first DL reference signal and a second DL reference signal exceeds the threshold Y, a measurement report is provided with the “DL delta propagation delay” as described in one of the examples mentioned in the present disclosure.

In a variant of this example, the UE can trigger a Type 1 random access procedure or a Type 2 random access procedure to report the “DL delta propagation delay” measurement.

In a variant of this example, the UE can trigger a configured grant PUSCH (of Type 1 or of Type 2) to report the “DL delta propagation delay” measurement.

This threshold Y can be configured/updated by RRC configuration and/or MAC CE signaling and/or L1 control (DCI) signaling.

In another example, the UE is configured to measure and report the “DL delta propagation delay” between a first DL reference signal and a second DL reference signal periodically: (1) UE autonomously changes delay; and (2) Different delays (i.e., timing advance) for each TCI state.

A UE is configured to measure the DL delta propagation delay of DL reference signals. The UE is configured or determines a reference signal (RS1) to use for DL reference timing. For example, the reference signal can be a reference associated with a source RS (e.g., QCL Type D or spatial relation source RS) of an indicated TCI state. The indicated TCI state can be a joint TCI state or an UL TCI state.

The UE detects a reference signal (RS2) with a signal quality (e.g., RSRP or SINR) that exceeds a threshold X, wherein X is configured/update by RRC signaling and/or MAC CE signaling and/or L1 control (DCI) signaling.

The UE measures the “DL delta propagation delay” between RS1 and RS2. If the “DL delta propagation delay” exceeds a threshold Y, wherein Y is configured/updated by RRC signaling and/or MAC CE signaling and/or L1 control (DCI) signaling, the UE triggers a random access procedure. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. The random access procedure determines the round trip delay associated with a RS2.

In one example, the first reference signal is associated with a first entity (e.g., TRP or cell or panel or CORESETPOOLIndex). The second reference signal is associated with a second entity (e.g., TRP or cell or panel or CORESETPOOLIndex).

In one example, a first TA group is associated with a first entity (e.g., TRP or cell or panel or CORESETPOOLIndex). A second TA group is associated with a second entity (e.g., TRP or cell or panel or CORESETPOOLIndex).

In one example, a UE measures the time of arrival of the first-in-time received or detected RS in the first set associated with a first entity or associated with a first TA group (or TA index within a TA group) and the UE measures the time of arrival of the first-in-time received or detected RS in the second set associated with a second entity or associated with a second TA group (or TA index within a TA group) and calculates the “DL delta propagation delay” between the two measurements based on the first-in-time received or detected RS of each group. In one example the RSes can be SSBs. In one example the RSes can be CSI-RS resources. In one example the RSes can be SSBs or CSI-RS resources.

In one example, a UE measures the time of arrival of the first-in-time received or detected RS that exceeds an RSRP threshold in the first set associated with a first entity or associated with a first TA group (or TA index within a TA group) and the UE measures the time of arrival of the first-in-time received or detected RS that exceeds an RSRP threshold in the second set associated with a second entity or associated with a second TA group (or TA index within a TA group) and calculates the “DL delta propagation delay” between the two measurements based on the first-in-time received or detected RS that exceeds the RSRP threshold of each group. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling.

In one example, a UE measures the time of arrival of the last-in-time received or detected RS in the first set associated with a first entity or associated with a first TA group (or TA index within a TA group) and the UE measures the time of arrival of the last-in-time received or detected RS in the second set associated with a second entity or associated with a second TA group (or TA index within a TA group) and calculates the “DL delta propagation delay” between the two measurements based on the last-in-time received or detected RS of each group. In one example the RSes can be SSBs. In one example the RSes can be CSI-RS resources. In one example the RSes can be SSBs or CSI-RS resources.

In one example, a UE measures the time of arrival of the last-in-time received or detected RS that exceeds an RSRP threshold in the first set associated with a first entity or associated with a first TA group (or TA index within a TA group) and the UE measures the time of arrival of the last-in-time received or detected RS that exceeds an RSRP threshold in the second set associated with a second entity or associated with a second TA group (or TA index within a TA group) and calculates the “DL delta propagation delay” between the two measurements based on the last-in-time received or detected RS that exceeds the RSRP threshold of each group. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling.

In one example, a UE measures the time of arrival of the strongest (e.g., largest RSRP or largest SINR or best signal quality) received or detected RS in the first set associated with a first entity or associated with a first TA group (or TA index within a TA group) and the UE measures the time of arrival of the strongest (e.g., largest RSRP or largest SINR or best signal quality) received or detected RS in the second set associated with a second entity or associated with a second TA group (or TA index within a TA group) and calculates the “DL delta propagation delay” between the two measurements based on the strongest (e.g., largest RSRP or largest SINR or best signal quality) received or detected RS of each group. In one example the RSes can be SSBs. In one example the RSes can be CSI-RS resources. In one example the RSes can be SSBs or CSI-RS resources.

In one example, a UE measures the average time of arrival of received or detected RSes in the first set associated with a first entity or associated with a first TA group (or TA index within a TA group) and the UE measures the average time of arrival of the received or detected RSes in the second set associated with a second entity or associated with a second TA group (or TA index within a TA group) and calculates the “DL delta propagation delay” between the two measurements. In one example the RSes can be SSBs. In one example the RSes can be CSI-RS resources. In one example the RSes can be SSBs or CSI-RS resources. In one example, the averaging of the time of arrival of the RSes can be weighted with the RSRP or SINR of each RS. In one example, the averaging of the time of arrival of the RSes is not weighted.

In one example, a UE measures the average time of arrival of the last-in-tme received or detected RSes that exceeds an RSRP threshold in the first set associated with a first entity or associated with a first TA group (or TA index within a TA group) and the UE measures the average time of arrival of the received or detected RSes that exceeds an RSRP threshold in the second set associated with a second entity or associated with a second TA group (or TA index within a TA group) and calculates the “DL delta propagation delay” between the two measurements. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling. In one example, the averaging of the time of arrival of the RSes can be weighted with the RSRP or SINR of each RS. In one example, the averaging of the time of arrival of the RSes is not weighted.

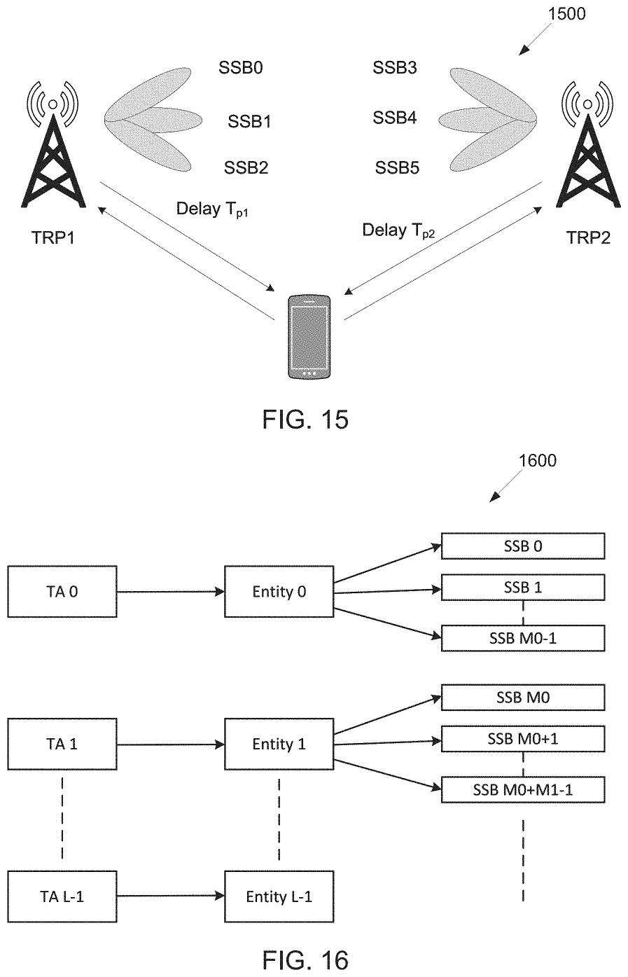

FIG. 15 illustrates an example of configuration of SSBs 1500 according to embodiments of the present disclosure. The embodiment of the configuration of SSBs 1500 illustrated in FIG. 15 is for illustration only.

In one example, e.g., as illustrated in FIG. 15, the UE is configured an association of SSBs with TA groups. For example, there is a first TA group associated with SSB₀, SSB₁, SSB₂, . . . SSB_{M-1}. There is a second TA group associated with SSB_{M}, SSB_{M+1}, SSB_{M+2} . . . SSB_{N-1}. Where, N is the total number of SSBs. M is the number of SSBs associated with the first TA group. N−M is the number of SSBs associated with the second TA group. In one example, the number of SSBs in each TA group is equal, i.e., M=N−M. In another example, there are more than 2 TA groups, the SSBs are partitioned among the more than 2 TA groups. In one example, the number SSBs per TA group can be the same. In another example, the number SSBs per TA group can be different.

In one example, if a RACH procedure is triggered using a preamble and a PRACH occasion (RO) associated with an SSB and the SSB is associated with a TA group, the TA in the RAR response is for the corresponding TA group.

In a further example, illustrated in FIG. 16, there can be L entities. For example, an entity can be a TRP or a cell or panel on a TRP or CORESETPOOLIndex.

An entity 0 is associated with a TA group 0 (or TA index 0 within a TA group) and is associated with a set 0 of SSBs, e.g., SSB₀,SSB₁, . . . SSB_{M-1}, where M₀ is the number of SSBs associated with the entity 0 and the TA group 0 (or TA index 0 within a TA group).

An entity 1 is associated with a TA group 1 (or TA index 1 within a TA group) and is associated with a set 1 of SSBs, e.g., SSB_{M}_{₀}, SSB_{M}_{₀}₊₁, . . . SSB_{M}_{₀}_{+M}_{₁}, where M₁ is the number of SSBs associated with the entity 1 and the TA group 1 (or TA index 1 within a TA group) . . . .

An entity L−1 is associated with a group L−1 (or TA index L−1 within a TA group L−1) and is associated with a set L−1 of SSBs, e.g., SSB_{Σ}_{ᵢ₌₀}_{^{L-2}}_{M}_{ᵢ}, SSB_{Σ}_{ᵢ₌₀}_{^{L-2}}_{M}_{ᵢ}₊₁, . . . SSB_{Σ}_{ᵢ₌₀}_{^{L-2}}_{M}_{ᵢ}₋₁, where Mᵢ is the number of SSBs associated with the entity i and the TA group i (or TA index i within a TA group), wherein i=0, . . . , L−1. Σᵢ₌₀^{L-1} Mᵢ=N, where N is the number of SSBs.

In one example, Mᵢ can be different for each entity.

In one example, M₀=M₁= . . . =M_{L-1}=M.

FIG. 16 illustrates an example of entities for TRP 1600 according to embodiments of the present disclosure. The embodiment of the entities for TRP 1600 illustrated in FIG. 16 is for illustration only.

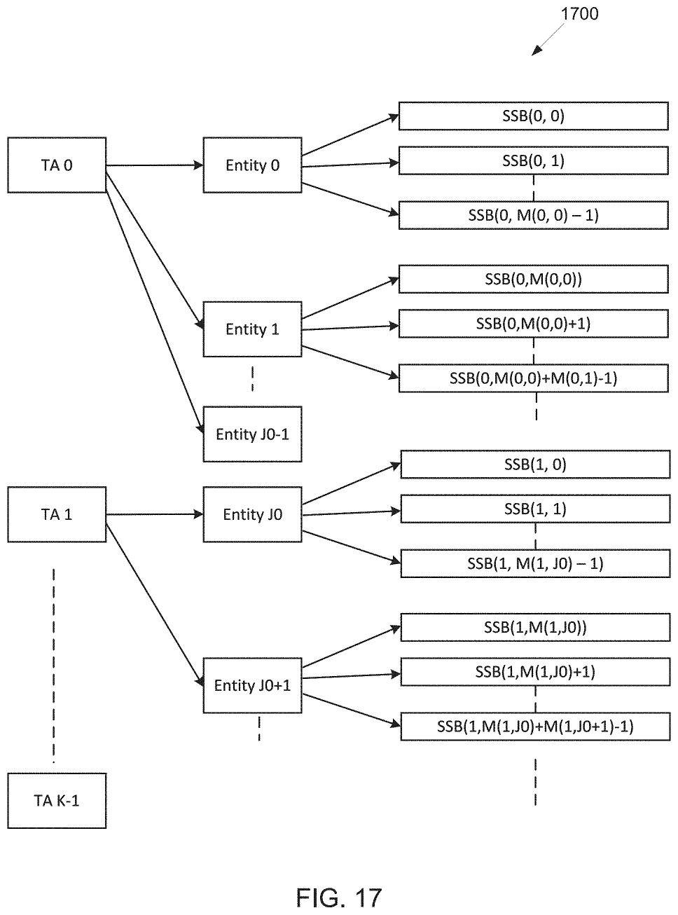

FIG. 17 illustrates another example of entities for TRP 1700 according to embodiments of the present disclosure. The embodiment of the entities for TRP 1700 illustrated in FIG. 17 is for illustration only.

In a further example, illustrated in FIG. 17, there can be L entities, and K TA groups. For example, an entity can be a TRP or a cell or panel on a TRP or a CORESETPOOLIndex as shown in TABLE 2.

```
TABLE 2
TA group 0 (or TA index 0 within a TA group) is associated with a
set 0 of entities, e.g., entity 0, entity 1, . . . entity J₀ − 1, where J₀ is
the number of entities associated with TA group 0 (or TA index 0
within a TA group).
  Entity 0 is associated with a set (0, 0) of SSBs, e.g.,
  SSB_{0,0}, SSB_{0,1}, . . . SSB_{0,M}_{_{0,0}}₋₁, where M_{0,0} is the number of SSBs
  associated with the entity 0 and the TA group 0 (or TA index 0
  within a TA group).
  Entity 1 is associated with a set (0, 1) of SSBs, e.g.,
  ${SSB}_{0 , {M}_{0 , 0}} , {SSB}_{0 , {M}_{0 , 0} + 1} , … {SSB}_{0 , {M}_{0 , 0} + {M}_{0 , 1} - 1} ,$
  where M_{0,1} is the number of SSBs associated with the entity 1 and
  the entity 1 and the TA group 0 (or TA index 0 within a TA group).
  . . .
  Entity J₀ − 1 is associated with a set (0, J₀ − 1) of SSBs e.g.,
  $S S {B}_{0 , {Σ}_{i = 0}^{{J}_{0} - 2} {M}_{0 , i}} , {SSB}_{0 , {Σ}_{i = 0}^{{J}_{0} - 2} {M}_{0 , i} + 1} , … {SSB}_{0 , {Σ}_{i = 0}^{{J}_{0} - 1} {M}_{0 , i} - 1} ,$
  where M_{0,i} is the number of SSBs associated with the entity i and
  the TA group 0 (or TA index 0 within a TA group).
TA group 1 (or TA index 1 within a TA group) is associated with a set
1 of entities, e.g., entity J₀, entity J₀ + 1, . . . entity J₀ + J₁ − 1, where
J₁ is the number of entities associated with TA group 1 (or TA index
1 within a TA group).
  Entity J₀ is associated with a set (1, J₀) of SSBs, e.g.,
  ${SSB}_{1 , 0} , {SSB}_{1 , 1} , … {SSB}_{1 , {M}_{1 , {J}_{0}} - 1} ,$
  where M_{1,J}_{₀} is the number of SSBs associated with the entity J₀ and
  the TA group 1 (or TA index 1 within a TA group).
  Entity J₀ + 1 is associated with a set (1, J₀ + 1) of SSBs, e.g.,
  ${SSB}_{1 , {M}_{1 , {J}_{0}}} , {SSB}_{1 , {M}_{1 , {J}_{0}} + 1} , … {SSB}_{1 , {M}_{1 , {J}_{0}} + {M}_{1 , {J}_{0} + 1} - 1} ,$
  where M_{1,J}_{₀}₊₁ is the number of SSBs associated with the entity
  J₀ + 1 and the TA group 1 (or TA index 1 within a TA group).
  . . .
  Entity J₀ + J₁ − 1 is associated with a set (1, J₀ + J₁ − 1) of
  SSBs, e.g.,
  ${SSB}_{1 , {Σ}_{i = {J}_{0}}^{{J}_{0} + {J}_{1} - 2} {M}_{1 , i}} , {SSB}_{1 , {Σ}_{i = {J}_{0}}^{{J}_{0} + {J}_{1} - 2} {M}_{1 , i} + 1} , … {SSB}_{1 , {Σ}_{i = {J}_{0}}^{{J}_{0} + {J}_{1} - 1} {M}_{1 , i} - 1} ,$
  where M_{1,i} is the number of SSBs associated with the entity i
  and the TA group 1 (or TA index 1 within a TA group).
. . .
TA group K − 1 (or TA index K − 1 within a TA group) is
associated with a set K − 1 of entities, e.g., entity Σⱼ₌₀^{K-2}Jⱼ,
entity Σⱼ₌₀^{K-2}Jⱼ + 1, . . . entity Σⱼ₌₀^{K-1}Jⱼ − 1,
where Jⱼ is the number of entities associated with TA group j
(or TA index j within a TA group).
  Entity Σⱼ₌₀^{K-2}Jⱼ is associated with a set (K − 1, entity Σⱼ₌₀^{K-2}Jⱼ)
  of SSBs, e.g.,
  ${SSB}_{K - 1 , 0} , {SSB}_{K - 1 , 1} , … {SSB}_{K - 1 , {Σ}_{j = 0}^{K - 2} {J}_{j} - 1} , where {M}_{K - 1 , {Σ}_{j = 0}^{K - 2} {J}_{j}}$
  is the number of SSBs associated with the entity entity Σⱼ₌₀^{K-2}Jⱼ
  and the TA group K − 1 (or TA index K − 1 within a TA group).
  Entity Σⱼ₌₀^{K-2}Jⱼ + 1 is associated with a set (K − 1,
  Σⱼ₌₀^{K-2}Jⱼ + 1) of SSBs, e.g.,
  $\begin{matrix}{SSB}_{K - 1 , {M}_{K - 1 , {Σ}_{j = 0}^{K - 2} {J}_{j}}} , {SSB}_{K - 1 , {M}_{K - 1 , {Σ}_{j = 0}^{K - 2} {J}_{j}} + 1} , … \\ {SSB}_{K - 1 , {M}_{K - 1 , {Σ}_{j = 0}^{K - 2} {J}_{j} + {M}_{K - 1 , {Σ}_{j = 0}^{K - 2} {J}_{j} + 1} - 1}} ,\end{matrix}$
  where M_{K-1,Σ}_{ⱼ₌₀}_{^{K−2}}_{J}_{ⱼ}₊₁ is the number of SSBs associated
  with the entity Σⱼ₌₀^{K-2}Jⱼ + 1 and the TA group K − 1 (or TA
  index K − 1 within a TA group).
  . . .
```

In one example, Σⱼ₌₀^{K-1}Jⱼ=L, where L is the number of entities across all TA groups (or TA indexes within a TA group). Jⱼ is the number of entities associated with TA group j or (TA index j with a TA group).

In one example, M_{i,j} can be different for each entity j and each TA group i (or TA index i within a TA group).

In one example, M_{i,j}=Mᵢ is the same value Mᵢ for any entity j associated with TA group i (or TA index i within a TA group). Where, Mᵢ is the number of SSB associated with any entity j associated with TA group i (or TA index i within a TA group).

In one example, M_{i,j}=M is the same value M for any entity j associated with any TA group i (or TA index i within a TA group). Where, M is the number of SSB associated with any entity j associated with any TA group i (or TA index i within a TA group).

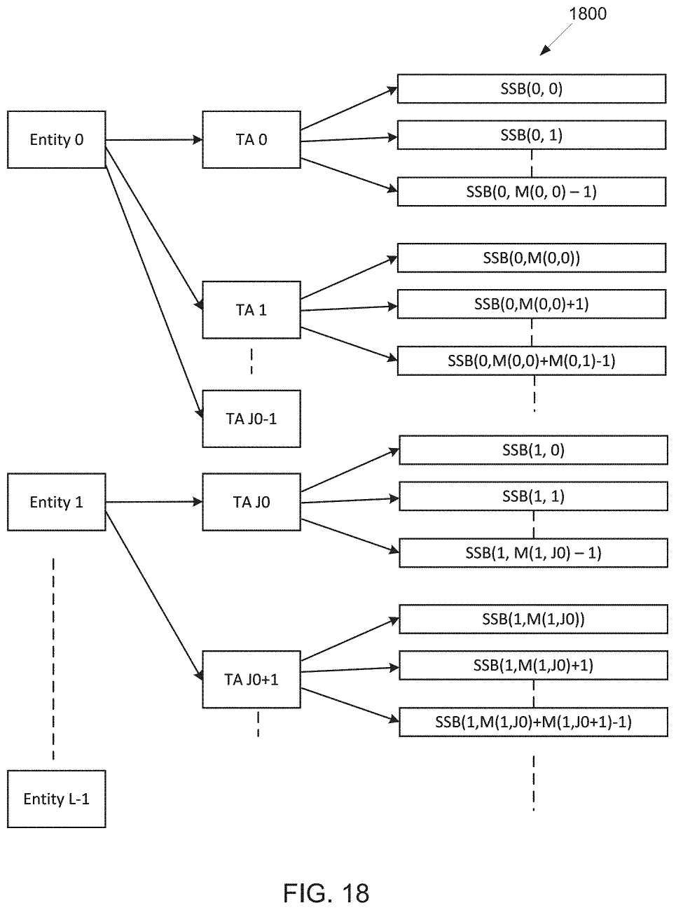

FIG. 18 illustrates yet another example of entities for TRP 1800 according to embodiments of the present disclosure. The embodiment of the entities for TRP 1800 illustrated in FIG. 18 is for illustration only.

In a further example, illustrated in FIG. 18, there can be L entities, and K TA groups (TA indexes within a TA group). For example, an entity can be a TRP or a cell or panel on a TRP or a CORESETPOOLIndex as shown in TABLE 3.

```
TABLE 3
An entity 0 is associated with a set 0 TA groups (or TA indexes within
a TA group), e.g., TA 0, TA 1, . . . TA J₀ − 1, TA J₀ is the
number of TA groups (or TA indexes within a TA group) associated
with entity 0.
  TA 0 is associated with a set (0,0) of SSBs, e.g.,
  ${SSB}_{0 , 0} , {SSB}_{0 , 1} , … {SSB}_{0 , {M}_{0 , 0} - 1} ,$
  where M_{0,0} is the number of SSBs associated with the TA 0
  and the entity 0.
  TA 1 is associated with a set (0, 1) of SSBs, e.g.,
  ${SSB}_{0 , {M}_{0 , 0}} , {SSB}_{0 , {M}_{0 , 0} + 1} , … {SSB}_{0 , {M}_{0 , 0} + {M}_{0 , 1} - 1} ,$
  where M_{0,1} is the number of SSBs associated with the TA 1 and
  entity 0.
  . . .
  TA J₀ − 1 is associated with a set (0, J₀ − 1) of SSBs,
  e.g.,
  ${SSB}_{0 , {Σ}_{i = 0}^{{J}_{0} - 2} {M}_{0 , i}} , {SSB}_{0 , {Σ}_{i = 0}^{{J}_{0} - 2} {M}_{0 , i} + 1} , … {SSB}_{0 , {Σ}_{i = 0}^{{J}_{0} - 1} {M}_{0 , i} - 1} ,$
  where M_{0,i} is the number of SSBs associated with the TA i and the
  entity 0.
An entity 1 is associated with a set 1 of TA groups (or TA indexes
within a TA group), e.g., TA J₀, TA J₀ + 1, . . . TA J₀ + J₁ − 1,
where J₁ is the number of TA groups (of TA indexes within a TA
group) associated with entity 1.
  TA J₀ is associated with a set (1, J₀) of SSBs, e.g.,
  ${SSB}_{1 , 0} , {SSB}_{1 , 1} , … {SSB}_{1 , {M}_{1 , {J}_{0} - 1}} ,$
  where M_{1,J}_{₀} is the number of SSBs associated with the
  TA J₀ and the entity 1.
  TA J₀ + 1 is associated with a set (1, J₀ + 1) of SSBs, e.g.,
  ${SSB}_{1 , {M}_{1 , {J}_{0}}} , {SSB}_{1 , {M}_{1 , {J}_{0}} + 1} , … {SSB}_{1 , {M}_{1 , {J}_{0}} + {M}_{1 , {J}_{0} + 1} - 1} , where {M}_{1 , {J}_{0} + 1}$
  is the number of SSBs associated with the TA J₀ + 1 and
  entity 1.
  . . .
  TA J₀ + J₁ − 1 is associated with a set (1, J₀ + J₁ − 1)
  of SSBs, e.g.,
  ${SSB}_{1 , {Σ}_{i = {J}_{0}}^{{J}_{0} + {J}_{1} - 2} {M}_{1 , i}} , {SSB}_{1 , {Σ}_{i = {J}_{0}}^{{J}_{0} + {J}_{1} - 2} {M}_{1 , i} + 1} , … {SSB}_{1 , {Σ}_{i = {J}_{0}}^{{J}_{0} + {J}_{1} - 1} {M}_{1 , i} - 1} ,$
  where M_{1,i} is the number of SSBs associated with the TA
  i and entity 1.
. . .
An entity K − 1 is associated with a set K − 1 of TA groups (or TA
indexes within a TA group), e.g.,
$TA {\sum }_{j = 0}^{K - 2} {J}_{j} , TA {\sum }_{j = 0}^{K - 2} {J}_{j} + 1 , … TA {\sum }_{j = 0}^{K - 1} {J}_{j} - 1 ,$
where Jⱼ is the number of TA groups (or TA indexes within a TA
group) associated with entity j.
  TA Σⱼ₌₀^{K-2}Jⱼ is associated with a set (K − 1,
  Σⱼ₌₀^{K-2}Jⱼ) of SSBs, e.g.,
  ${SSB}_{K - 1 , 0} , {SSB}_{K - 1 , 1} , … {SSB}_{K - 1 , {M}_{K - 1 , {Σ}_{j = 0}^{K - 2} {J}_{j}} - 1} , where {M}_{K - 1 , {Σ}_{j = 0}^{K - 2} {J}_{j}}$
  is the number of SSBs associated with TA Σⱼ₌₀^{K-2}Jⱼ and entity K − 1.
  TA Σⱼ₌₀^{K-2}Jⱼ + 1 is associated with a set (K − 1, Σⱼ₌₀^{K-2}Jⱼ + 1)
  of SSBs, e.g.,
  $\begin{matrix}{SSB}_{K - 1 , {M}_{K - 1 , {J}_{0}}} , {SSB}_{K - 1 , {M}_{K - 1 , {Σ}_{j = 0}^{K - 2} {J}_{j}} + 1} , … \\ {SSB}_{K - 1 , {M}_{K - 1 , {Σ}_{j = 0}^{K - 2} {J}_{j} + {M}_{K - 1 , {Σ}_{j = 0}^{K - 2} {J}_{j} + 1} - 1} ,}\end{matrix}$
  where M_{K-1,Σ}_{ⱼ₌₀}_{^{K−2}}_{J}_{ⱼ}₊₁ is the number of SSBs associated
  with TA Σⱼ₌₀^{K-2}Jⱼ +1 and entity K − 1.
  . . .
```

In one example, Σⱼ₌₀^{L-1}Jⱼ=K, where K is the number of TA groups (or TA indexes in a TA group) across all entities. Jⱼ is the number of TA groups (or TA indexes within a TA group) associated with entity j.

In one example, M_{i,j} can be different for each TA group j (or TA index j within a TA group) and each entity i.

In one example, M_{i,j}=Mᵢ is the same value Mᵢ for any TA group j (or TA index j within a TA group) associated with entity i. Where, Mᵢ is the number of SSB associated with any TA group j (or TA index j within a TA group) associated with entity i.

In one example, M_{i,j}=M is the same value M for any TA group j (or TA index j within a TA group) associated with any entity i. Where, M is the number of SSB associated with any TA group j (or TA index j within a TA group) associated with any entity i.

In one example, the UE is configured an association of CSI-RS resources with TA groups. For example, there is a first TA group associated with CSIRS₀, CSIRS₁, CSIRS₂, . . . CSIRS_{M-1}. There is a second TA group associated with CSIRS_{M}, CSIRS_{M+1}, CSIRS_{M+2}, . . . CSIRS_{N-1}. Where, N is the total number of CSI-RS resources. M is the number of CSI-RS resources associated with the first TA group. N−M is the number of CSI-RS resources associated with the second TA group. In one example, the number of CSI-RS resources in each TA group is equal, i.e., M=N−M. In another example, there are more than 2 TA groups, the CSI-RS resources are partitioned among the more than 2 TA groups. In one example, the number CSI-RS resources per TA group can be the same. In another example, the number CSI-RS resources per TA group can be different.

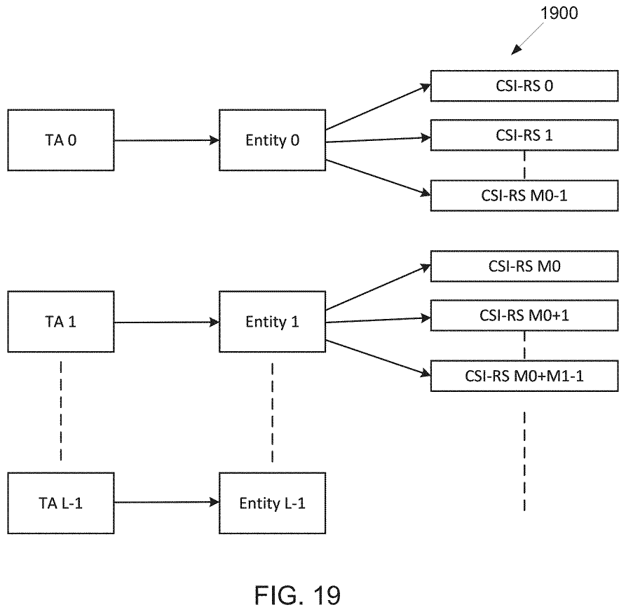

FIG. 19 illustrates yet another example of entities for TRP 1900 according to embodiments of the present disclosure. The embodiment of the entities for TRP 1900 illustrated in FIG. 19 is for illustration only.

In a further example, illustrated in FIG. 19, there can be L entities. For example, an entity can be a TRP or a cell or panel on a TRP or a CORESETPOOLIndex. Entity i is associated with TA group i (or TA index i within a TA group). A set of Mᵢ CSI-RS resources are associated entity i and TA group i (or TA index i within a TA group).

In one example, Mᵢ can be different for each entity.

In one example, M₀=M₁= . . . =M_{L-1}=M.

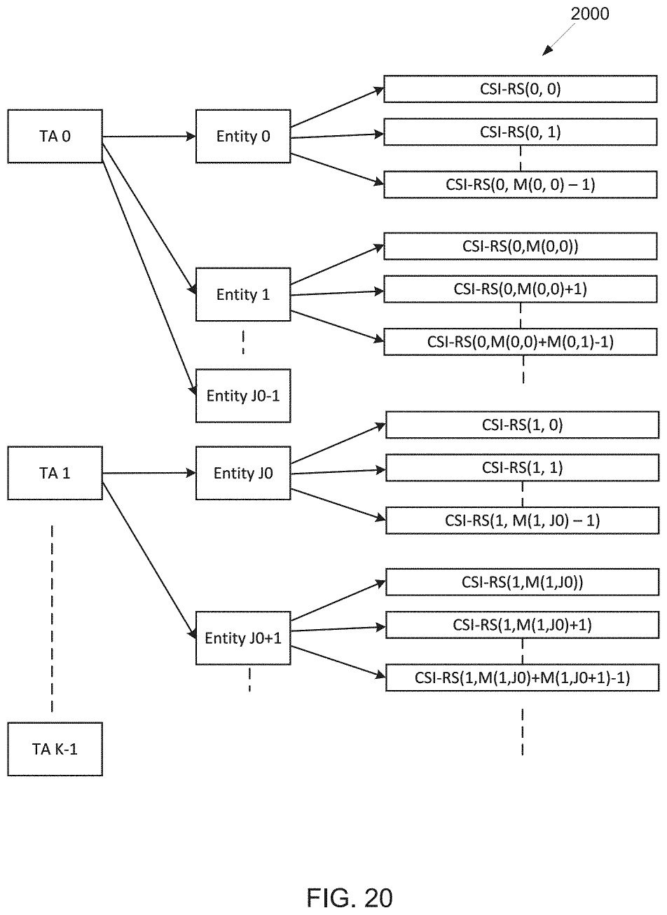

FIG. 20 illustrates yet another example of entities for TRP 2000 according to embodiments of the present disclosure. The embodiment of the entities for TRP 2000 illustrated in FIG. 20 is for illustration only.

In a further example, illustrated in FIG. 20, there can be L entities, and K TA groups. For example, an entity can be a TRP or a cell or panel on a TRP. A TA group i (or TA index i within a TA group) is associated with a set of Ji entities. A set of Mg, CSI-RS resources are associated entity j, wherein entity j is associated with TA group i (or TA index i within a TA group).

In one example, Σᵢ₌₀^{K-1}Jᵢ=L, where L is the number of entities across all TA groups (or TA indexes within a TA group). Jᵢ is the number of entities associated with TA group i or (TA index i with a TA group).

In one example, M_{i,j} can be different for each entity j and each TA group i (or TA index i within a TA group).

In one example, M_{i,j}=Mᵢ is the same value Mᵢ for any entity j associated with TA group i (or TA index i within a TA group). Where, Mᵢ is the number of SSB associated with any entity j associated with TA group i (or TA index i within a TA group).

In one example, M_{i,j}=M is the same value M for any entity j associated with any TA group i (or TA index i within a TA group). Where, M is the number of SSB associated with any entity j associated with any TA group i (or TA index i within a TA group).

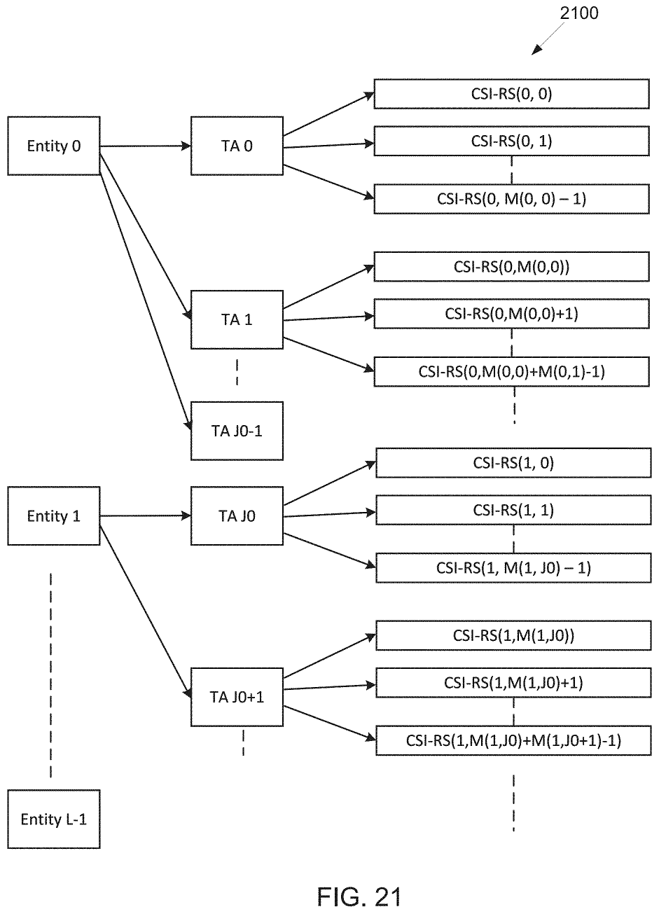

FIG. 21 illustrates yet another example of entities for TRP 2100 according to embodiments of the present disclosure. The embodiment of the entities for TRP 2100 illustrated in FIG. 21 is for illustration only.

In a further example, illustrated in FIG. 21, there can be L entities, and K TA groups. For example, an entity can be a TRP or a cell or panel on a TRP or a CORESETPOOLIndex. An entity i is associated with a set of Jⱼ TA groups (or TA indexes within a TA group). A set of Mg, CSI-RS resources are associated TA group j (or TA index j within a TA group), wherein TA group j (or TA index j within a TA group) is associated with entity i.

In one example, Σⱼ₌₀^{L-1}Jᵢ=K, where K is the number of TA groups (or TA indexes in a TA group) across all entities. Jⱼ is the number of TA groups (or TA indexes within a TA group) associated with entity j.

In one example, M_{i,j} can be different for each TA group j (or TA index j within a TA group) and each entity i.

In one example, M_{i,j}=Mᵢ is the same value Mᵢ for any TA group j (or TA index j within a TA group) associated with entity i. Where, Mᵢ is the number of SSB associated with any TA group j (or TA index j within a TA group) associated with entity i.

In one example, M_{i,j}=M is the same value M for any TA group j (or TA index j within a TA group) associated with any entity i. Where, M is the number of SSB associated with any TA group j (or TA index j within a TA group) associated with any entity i.

In one example, if a RACH procedure is triggered using a preamble and a PRACH Occasion (RO) associated with an SSB that is a QCL source (direct QCL or indirect QCL) for the CSI-RS and the SSB is associated with a TA group, the TA in the RAR response is for the corresponding TA group.

In one example, there is no threshold X configured, the UE measures the difference in DL propagation time (DL delta propagation delay) between RS1 and RS2, to determine if it exceeds a threshold Y and if it does, the UE triggers a random access procedure.

In one example, the UE operates with a single TA. If the difference in DL propagation time (DL delta propagation delay) between RS1 and RS2 exceeds a threshold Y, the UE triggers a random access procedure, when the random access procedure is successful, the UE switches to two TA mode. In one example, the UE is signaled two TA values in the RAR, a first TA value for channels/signals or TCI states or CORESETs associated with RS1 or a first TA group (or TA index) and a second TA value for channels/signals or TCI states or CORESETs associated with RS2 or a second TA group (or TA index). In one example, the UE is signaled a TA value in the RAR, the TA value is for channels/signals or TCI states or CORESETs associated with RS, or the TA group associated with the random access procedure.

In one example, the UE is signaled two TA values, a first TA value for channels/signals or TCI states or CORESETs associated with RS1 or a first TA group and a second TA value for channels/signals or TCI states or CORESETs associated with RS2 or a second TA group. In one example, a channel/signal or TCI state or CORESET is said to be associated with RS1 or first TA group, if the channel/signal or TCI state or CORESET is received (or transmitted) by the same entity (e.g., TRP or panel or cell or CORESETPOOLIndex) transmitting RS1 or the same entity (e.g., TRP or panel or cell or CORESETPOOLIndex) associated with the first TA group. In one example, a channel/signal or TCI state or CORESET is said to be associated with RS2 or second TA group, if the channel/signal or TCI state or CORESET is received (or transmitted) by the same entity (e.g., TRP or panel or cell or CORESETPOOLIndex) transmitting RS2 or the same entity (e.g., TRP or panel or cell or CORESETPOOLIndex) associated with the second TA group.

In one example, a channel/signal is said to be associated with RS1, if the channel/signal is received (or transmitted) has a same quasi-co-location reference signal as RS1, in one example, the QCL is Type-D QCL. In one example, a channel/signal is said to be associated with RS2, if the channel/signal is received (or transmitted) has a same quasi-co-location reference signal as RS2, in one example, the QCL is Type-D QCL. In one example, the RACH procedure is triggered by the UE.

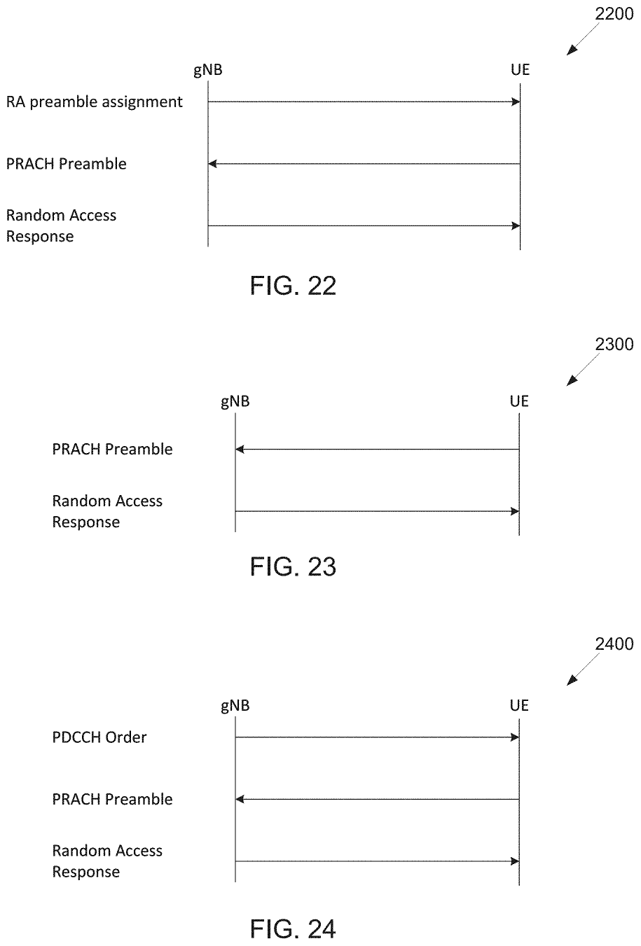

FIG. 22 illustrates an example of higher-layer triggered CFRA procedure 2200 according to embodiments of the present disclosure, as may be performed by a UE (e.g., 111-116 as illustrated in FIG. 1) and a base station (e.g., 101-103 as illustrated in FIG. 1). An embodiment of the higher-layer triggered CFRA procedure 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions.

FIG. 23 illustrates an example of higher-layer triggered CBRA procedure 2300 according to embodiments of the present disclosure, as may be performed by a UE (e.g., 111-116 as illustrated in FIG. 1) and a base station (e.g., 101-103 as illustrated in FIG. 1). An embodiment of the higher-layer triggered CBRA procedure 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

In one example, random access procedure is a Type 1 contention-based random access procedure to determine a TA as illustrated in FIG. 23.

In one example 2.2, random access procedure is a Type 1 contention-free random access procedure to determine a TA as illustrated in FIG. 22.

In one example 2.3, random access procedure is a Type 2 contention-based random access procedure to determine a TA.

In one example 2.4, random access procedure is a Type 2 contention-free random access procedure to determine a TA.

In one embodiment, the network measures the time of arrival of an UL signal from the UE at TRP B relative to the reference time of, e.g., TRP B (e.g., TRP B's Rx reference time). In one example, the time of arrival can be based on the first-in-time received or detected reference signal. In one example, the time of arrival can be based on the first-in-time received or detected reference signal that exceeds an RSRP threshold, wherein the RSRP threshold can be configured and/or updated by RRC signaling and/or MAC CE signaling and/or L1 control signaling. In one example, the time of arrival can be based on the last-in-time received or detected reference signal.

In one example, the time of arrival can be based on the last-in-time received or detected reference signal that exceeds an RSRP threshold, wherein the RSRP threshold can be configured and/or updated by RRC signaling and/or MAC CE signaling and/or L1 control signaling. In one example, the time of arrival can be based on the strongest (e.g., largest RSRP or largest SINR or best signal quality). In one example, the time of arrival can be based on the strongest (e.g., largest RSRP or largest SINR or best signal quality) received or detected reference signal. In one example, the time of arrival can be an average of the received or detected reference signals.

In one example, the time of arrival can be an average of the received or detected reference signals that exceed a RSRP threshold, wherein the RSRP threshold can be configured and/or updated by RRC signaling and/or MAC CE signaling and/or L1 control signaling.

If the difference between the arrival time of the UL signal at TRP B and the reference time of TRP B (e.g., TRP B's Rx reference time), exceeds a threshold X, wherein X is configured/update by RRC signaling and/or MAC CE signaling and/or L1 control (DCI) signaling, the network can trigger a PDCCH order for a random access procedure towards the UE for the UE to transmit PRACH preamble.

In one example the threshold X can be specified in the system specifications, e.g., X equals half the cyclic prefix, or X equals quarter the cyclic prefix, or X equals the cyclic prefix. In one example, a value X specified in the system specifications (e.g., default value) can be used, unless a different value is configured. The network can measure the round trip delay between the UE and TRP. In one example, the RACH procedure is triggered by the network.

In one example for a CFRA-based higher-layer trigger random access procedure the following examples can apply.

FIG. 22 illustrates a higher-layer triggered CFRA procedure. The following aspects are considered: (1) the resource for the preamble transmission, wherein the resource includes the PRACH Occasion and the preamble index; (2) the spatial filter and/or transmit power used to transmit the preamble; and (3) the quasi-co-location for the random access response.

In one example, the UE determines the TRP and/or the SSB to use for sending the contention-free random access preamble. For example, the TRP can be determined based on the activated TCI state codepoints (or TCI states or TCI state IDs) and/or the activated spatial relations. In one example, let X1 be the set of TRPs associated with the MAC CE activated TCI state codepoints e.g., as described in TS 38.321, the UE selects (or determines) a TRP Y1 from set X1, the UE further selects (or determines) an SSB index Z1 associated with TRP Y1, the UE uses SSB index Z1 to determine the spatial filter and/or power of the preamble transmission.

In one example, let X2 be the set of TRPs associated with the MAC CE activated spatial relation information, the UE selects (or determines) a TRP Y2 from set X2, the UE further selects (or determines) an SSB index Z2 associated with TRP Y2, the UE uses SSB index Z2 to determine the spatial filter and/or power of the preamble transmission. The UE transmits the higher layer indicated preamble in a PRACH Occasion corresponding to Z1/Y1 or Z2/Y2.

In one example, active TCI states (or TCI state codepoints or active spatial relations) can be associated with two TRPs. In one example, active TCI states (or TCI state codepoints or active spatial relations) can be associated with two or more TRPs.

In one example, the preamble is transmitted using a spatial filter and/or a power determined based on a TRP and a SSB index (e.g., determined as described in one or more examples herein). The RO for the CFRA preamble transmission can also be determined based on the SSB index as described in TS 38.213.

In one example, the random access response for the preamble is transmitted in a PDCCH with a CRC that is scrambled by RA-RNTI.

In one example, the PDCCH of the RAR is transmitted in a Type1-PDCCH common search space (CSS) set associated with the serving cell.

In one example, the PDCCH of the RAR is transmitted in a USS set.

In one example, the DMRS antenna port of the PDCCH of the RAR is quasi-co-located with the SSB or CSI-RS resource used to determine the spatial filter and/or power of the preamble transmission.

In one example, the DMRS antenna port of the PDCCH of the RAR is quasi-co-located with the SSB or CSI-RS resource used to determine the association of the preamble transmission to ROs.

In one example, the DMRS antenna port of the PDCCH of the RAR is quasi-co-located with a CORESET (e.g., based on source RS of TCI state of the CORESET) associated with Type1-PDCCH CSS set.

In one example, the DMRS antenna port of the PDCCH of the RAR is quasi-co-located with a CORESET (e.g., based on source RS of TCI state of the CORESET) associated with USS set.

In one example for a CBRA-based higher-layer trigger random access procedure the following examples can apply:

FIG. 23 illustrates a higher-layer triggered CBRA procedure. The following aspects are considered: (1) the resource for the preamble transmission, wherein the resource includes the PRACH Occasion and the preamble index; (2) the spatial filter and/or transmit power used to transmit the preamble; and (3) the quasi-co-location for the random access response.

The resource used for the preamble is determined by a PRACH Occasion and a preamble index within the PRACH Occasion. For higher layer triggered CBRA procedure, the UE can randomly select a preamble from the contention based preambles associated with the selected SSB. The PRACH Occasion is determined based on an SSB or a CSI-RS resource to which the preamble is associated with, through an association pattern as described in TS 38.213.

In one example, the UE determines the TRP and/or the SSB to use for sending the contention-based random access preamble. For example, the TRP can be determined based on the activated TCI state codepoints (or TCI states or TCI state IDs) and/or the activated spatial relations. In one example, let X1 be the set of TRPs associated with the MAC CE activated TCI state codepoints e.g., as described in TS 38.321, the UE selects (or determines) a TRP Y1 from set X1, the UE further selects (or determines) an SSB index Z1 associated with TRP Y1, the UE uses SSB index Z1 to determine the spatial filter and/or power of the preamble transmission.

In one example, let X2 be the set of TRPs associated with the MAC CE activated spatial relation information, the UE selects (or determines) a TRP Y2 from set X2, the UE further selects (or determines) an SSB index Z2 associated with TRP Y2, the UE uses SSB index Z2 to determine the spatial filter and/or power of the preamble transmission. The UE randomly selects a preamble in a set of preambles for contention-based random access and a PRACH Occasion corresponding to Z1/Y1 or Z2/Y2.

In one example, active TCI states (or TCI state codepoints or active spatial relations) can be associated with two TRPs. In one example, active TCI states (or TCI state codepoints or active spatial relations) can be associated with two or more TRPs.

In one example, the preamble is transmitted using a spatial filter and/or a power determined based on a TRP and/or a SSB index (e.g., determined as described in one or more examples herein). The RO for the CBRA preamble transmission can also be determined based on the SSB index as described in TS 38.213. The UE randomly selects a preamble in a set of preambles for contention-based random access and a PRACH Occasion corresponding to the determined (or selected) TRP/TA/TAG index and SSB index.

In one example, the random access response for the preamble is transmitted in a PDCCH with a CRC that is scrambled by RA-RNTI.

In one example, the PDCCH of the RAR is transmitted in a Type1-PDCCH Common Search Space (CSS) set associated with the serving cell.

In one example, the DMRS antenna port of the PDCCH of the RAR is quasi-co-located with the SSB or CSI-RS resource used to determine the spatial filter and/or power of the preamble transmission and/or to determine the association of the preamble transmission to ROs.

In one example, the DMRS antenna port of the PDCCH of the RAR is quasi-co-located with the SSB or CSI-RS resource used to determine the association of the preamble transmission to ROs.

In one example, the DMRS antenna port of the PDCCH of the RAR is quasi-co-located with a CORESET (e.g., based on source RS of TCI state of the CORESET) associated with Type1-PDCCH CSS set.

FIG. 24 illustrates an example of PDCCH order triggered CFRA or CBRA procedure 2400 according to embodiments of the present disclosure, as may be performed by a UE (e.g., 111-116 as illustrated in FIG. 1) and a base station (e.g., 101-103 as illustrated in FIG. 1). An embodiment of the PDCCH order triggered CFRA procedure 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions.

In one example, the PDCCH order triggers a Type 1 contention-based random access procedure to determine a TA as illustrated in FIG. 24.

In one example, the PDCCH order triggers a Type 1 contention-free random access procedure to determine a TA as illustrated in FIG. 24.

In one example, the PDCCH order triggers a Type 2 contention-based random access procedure to determine a TA.

In one example, the PDCCH order triggers a Type 2 contention-free random access procedure to determine a TA.

FIG. 24 illustrates an example of a PDCCH order triggered CFRA procedure. The following aspects are considered: (1) the TRP, beam and/or quasi-co-location properties used to transmit the PDCCH order; (2) the resource for the preamble transmission, wherein the resource includes the PRACH Occasion and the preamble index; (3) the spatial filter and/or transmit power used to transmit the preamble; and (4) the quasi-co-location for the random access response.

The resource used for the preamble is determined by a PRACH Occasion and a preamble index within the PRACH Occasion.

For CFRA-based PDCCH Order, the preamble index can be indicated by the PDCCH order. The PRACH Occasion is determined based on an SSB or a CSI-RS resource to which the preamble is associated with, through an association pattern as described in TS 38.213. The spatial filter and/or power of the preamble transmission can be determined based on SSB resource (or CSI-RS resources) associated with the source RS of TCI state used by PDCCH of the PDCCH order.

For CBRA-based PDCCH order, the “random access preamble index” field is all zeros as aforementioned. In this case, UE can randomly select a preamble from the contention based preambles associated with the selected SSB, e.g., selected SSB is associated with target TAG (or TA index within a TAG) the association is as aforementioned, and the TA in the RAR corresponds to the TAG associated with the SSB. The PRACH Occasion is determined based on an SSB or a CSI-RS resource to which the preamble is associated with, through an association pattern as described in TS 38.213. The spatial filter and/or power of the preamble transmission can be determined based on SSB resource used for the RO of the preamble transmission.

In one example, a PRACH transmission from a UE is in response to a detection of a PDCCH order by the UE that triggers a contention-free random access procedure DL RS that the DM-RS of the PDCCH order is quasi-collocated with (e.g., source of TCI state applied to PDCCH order) can be SSB or CSI-RS.

If the DL RS of the DM-RS of the PDCCH is an SSB, the PRACH spatial domain transmission filter is determined based on the SSB (for example, the UE has beam correspondence). If the DL RS of the DM-RS of the PDCCH is an SSB, and the SSB is associated with a TAG or TA index within a TAG (e.g., a first TAG or a second TAG), the TA in the RAR corresponds to the TAG associated with the SSB.

If the DL RS of the DM-RS of the PDCCH is a CSI-RS resource, the PRACH spatial domain transmission filter is determined based on the CSI-RS resource (for example, the UE has beam correspondence). If the DL RS of the DM-RS of the PDCCH is a CSI-RS resource, and the CSI-RS resource is associated with a TAG or TA index within a TAG (e.g., a first TAG or a second TAG), the TA in the RAR corresponds to the TAG associated with the CSI-RS resource.

If the DL RS of the DM-RS of the PDCCH is a CSI-RS resource, and the CSI-RS resource is QCLed with an SSB and the SSB is associated with a TAG or TA index within a TAG (e.g., a first TAG or a second TAG), the TA in the RAR corresponds to the TAG associated with the SSB that is a QCL source for the CSI-RS resource. In one example, the QCL is Type-D QCL. The QCL to the SSB can be direct QCL or indirect QCL.

In one example, the DCI of the PDCCH order includes an SSB. The SSB is associated with a TAG or TA index within a TAG (e.g., a first TAG or a second TAG), the TA in the RAR corresponds to the TAG associated with the SSB.

In one example, the DCI of the PDCCH order includes flag. The flag indicates a TAG or TA index within a TAG (e.g., a first TAG or a second TAG), the TA in the RAR corresponds to the TAG indicated by the flag.

In one example, the PDCCH order is triggered by an entity (e.g., TRP or cell or panel or CORESETPOOLIndex) for which the TA is to be calculated.

In one example, the PDCCH order can be triggered by an entity (e.g., TRP or cell or panel or CORESETPOOLIndex) different from the entity for which the TA is to be calculated, for example cross-TRP PDCCH order triggering of preamble. In one example the entity for which the TA is to be calculated can be indicated by an SSB in the PDCCH order wherein the SSB is associated with the entity for which the TA is being calculated. In one example the entity for which the TA is to be calculated can be indicated by a flag or parameter in the PDCCH order wherein the flag or parameter in the PDCCH order is for the entity for which the TA is being calculated.

In one example, the PDCCH order can trigger two preamble transmission; (1) a first preamble transmission for a first entity or TAG or TA index in a TAG, (2) a second preamble transmission for a second entity or TA group or TA index in a TA group. In one example, there can be one RAR for the two preambles. In another example, there can be two RARs one for each preamble. In one example, when there is one RAR for the two preambles, the RAR can be sent from the entity that triggered the PDCCH order.

In one example, the PDCCH order can trigger a contention-based random access procedure. In one example, the contention-based PDCCH order can be used for transmitting a preamble associated with a TRP different from the TRP that triggered the PDCCH order.

In one embodiment, the network measures the time of arrival of an UL signal from the UE at TRP B relative to the reference time of, e.g., TRP B (e.g., TRP B's Rx reference time). In one example, the time of arrival can be based on the first-in-time received or detected reference signal. In one example, the time of arrival can be based on the first-in-time received or detected reference signal that exceeds an RSRP threshold, wherein the RSRP threshold can be configured and/or updated by RRC signaling and/or MAC CE signaling and/or L1 control signaling.

In one example, the time of arrival can be based on the last-in-time received or detected reference signal. In one example, the time of arrival can be based on the last-in-time received or detected reference signal that exceeds an RSRP threshold, wherein the RSRP threshold can be configured and/or updated by RRC signaling and/or MAC CE signaling and/or L1 control signaling. In one example, the time of arrival can be based on the strongest (e.g., largest RSRP or largest SINR or best signal quality). In one example, the time of arrival can be based on the strongest (e.g., largest RSRP or largest SINR or best signal quality) received or detected reference signal. In one example, the time of arrival can be an average of the received or detected reference signals.

In one example, the time of arrival can be an average of the received or detected reference signals that exceed a RSRP threshold, wherein the RSRP threshold can be configured and/or updated by RRC signaling and/or MAC CE signaling and/or L1 control signaling.

If the difference between the arrival time of the UL signal at TRP B and the reference time of TRP B (e.g., TRP B's Rx reference time), exceeds a threshold X, wherein X is configured/update by RRC signaling and/or MAC CE signaling and/or L1 control (DCI) signaling, the network can trigger or configure the UE to transmit a sounding reference signal (SRS).

In one example the threshold X can be specified in the system specifications, e.g., X equals half the cyclic prefix, or X equals quarter the cyclic prefix, or X equals the cyclic prefix. In one example, a value X specified in the system specifications (e.g., default value) can be used, unless a different value is configured. The network can measure the arrival time of the SRS transmitted by the UE at TRP B, and according determine the TA value for transmissions towards TRP B.

In one example for a CFRA-based PDCCH order the following examples can apply.

In one example, as illustrated in FIG. 22, the preamble is transmitted using a spatial filter and/or a power determined based on SS/PBCH index included in (or indicated by) the PDCCH order. The following variants can be considered for this example: (1) variant 1: the same SS/PBCH index is used to (1) determine the PRACH Occasion used to transmit the preamble and (2) determine the spatial filter and/or a power of the preamble; and (2) variant 2: the PDCCH order includes 2 SS/PBCH indices; (i) one is used to determine the PRACH Occasion used to transmit the preamble and (ii) the other is used to determine the spatial filter and/or a power of the preamble.

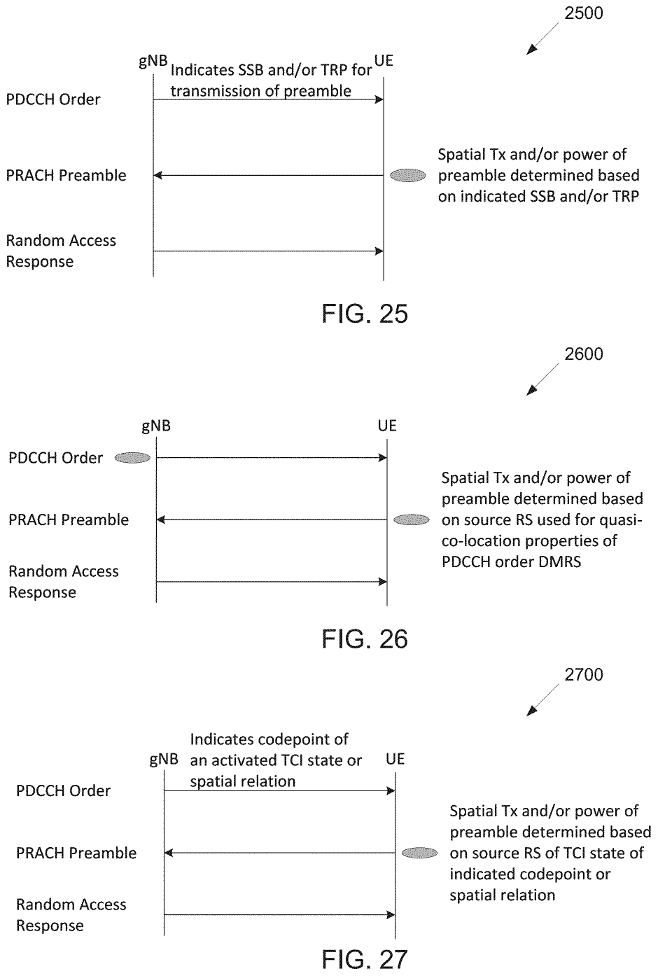

FIG. 25 illustrates an example of signaling flow for a preamble transmission based on SS/PBCH block 2500 according to embodiments of the present disclosure, as may be performed by a UE (e.g., 111-116 as illustrated in FIG. 1) and a base station (e.g., 101-103 as illustrated in FIG. 1). An embodiment of the signaling flow for a preamble transmission based on SS/PBCH block 2500 shown in FIG. 25 is for illustration only. One or more of the components illustrated in FIG. 25 can be implemented in specialized circuitry configured to perform the noted functions or one or more of the components can be implemented by one or more processors executing instructions to perform the noted functions.

In one example as illustrated in FIG. 25, the preamble is transmitted using a spatial filter and/or a power determined based on SS/PBCH index, wherein the SS/PBCH index is selected by the UE and it corresponds to flag included in (or indicated by) the PDCCH order. The flag can indicate a TRP and/or a TAG/TA to which the selected SS/PBCH index can be associated, wherein the association is as aforementioned.

FIG. 26 illustrates another example of signaling flow for a preamble transmission based on SS/PBCH block 2600 according to embodiments of the present disclosure, as may be performed by a UE (e.g., 111-116 as illustrated in FIG. 1) and a base station (e.g., 101-103 as illustrated in FIG. 1). An embodiment of the signaling flow for a preamble transmission based on SS/PBCH block 2600 shown in FIG. 26 is for illustration only. One or more of the components illustrated in FIG. 26 can be implemented in specialized circuitry configured to perform the noted functions or one or more of the components can be implemented by one or more processors executing instructions to perform the noted functions.

In one example as illustrated in FIG. 26, the preamble is transmitted using a spatial filter and/or a power determined based on an SSB or a CSI-RS resource that is the source RS or that is quasi-co-located with the source RS of the PDCCH DM-RS of the PDCCH order. The SS/PBCH index and/or CSI-RS is associated with a TAG or a TA index within a TAG as aforementioned.

FIG. 27 illustrates yet another example of signaling flow for a preamble transmission based on SS/PBCH block 2700 according to embodiments of the present disclosure, as may be performed by a UE (e.g., 111-116 as illustrated in FIG. 1) and a base station (e.g., 101-103 as illustrated in FIG. 1). An embodiment of the signaling flow for a preamble transmission based on SS/PBCH block 2700 shown in FIG. 27 is for illustration only. One or more of the components illustrated in FIG. 27 can be implemented in specialized circuitry configured to perform the noted functions or one or more of the components can be implemented by one or more processors executing instructions to perform the noted functions.

In one example as illustrated in FIG. 27 the preamble is transmitted using a spatial filter and/or a power determined based on an SS/PBCH index or CSI-RS resource, wherein the SS/PBCH index or CSI-RS resource is the source RS for quasi-co-location (e.g., TypeD QCL or TypeA QCL) of a MAC CE activated TCI state, wherein, the activated MAC CE TCI state codepoint (or TCI state or TCI state ID) is included in (or indicated by) the PDCCH order. Active TCI state code points correspond to TCI states activated by MAC CE as described in TS 38.321. The SS/PBCH index and/or CSI-RS is associated with a TAG or a TA index within a TAG as aforementioned.

In a variant example, an SSB index is used to determine the spatial filter and/or a power of the transmitted preamble, wherein, the SSB index is root source RS of a TCI state codepoint (or TCI state or TCI state ID) included in (or indicated by) the PDCCH order. The root source RS is a direct or indirect RS for QCL information or spatial relation information of the TCI state codepoint (or TCI state or TCI state ID). A direct RS is when the RS is the source RS of the TCI state codepoint (or TCI state or TCI state ID), an indirect RS, is when the RS provides QCL information or spatial relation information for the source RS of the TCI state codepoint (or TCI state or TCI state ID). The SS/PBCH index and/or CSI-RS is associated with a TAG or a TA index within a TAG as aforementioned.

In one example as illustrated in FIG. 27 the preamble is transmitted using a spatial filter and/or a power determined based on an SS/PBCH index or CSI-RS resource, wherein the SS/PBCH index or CSI-RS resource is the source RS for spatial relation of a MAC CE activated spatial relation, wherein, the activated MAC CE spatial relation (or spatial relation codepoint or spatial relation ID) is included in (or indicated by) the PDCCH order. The SS/PBCH index and/or CSI-RS is associated with a TAG or a TA index within a TAG as aforementioned.

In a variant example, an SSB index is used to determine the spatial filter and/or a power of the transmitted preamble, wherein, the SSB index is root source RS of a spatial relation (or spatial relation codepoint or spatial relation ID) included in (or indicated by) the PDCCH order. The root source RS is a direct or indirect RS for QCL information or spatial relation information of the spatial relation (or spatial relation codepoint or spatial relation ID). A direct RS is when the RS is the source RS of the spatial relation (or spatial relation codepoint or spatial relation ID), an indirect RS, is when the RS provides QCL information or spatial relation information for the source RS of the spatial relation (or spatial relation codepoint or spatial relation ID). The SS/PBCH index is associated with a TAG or a TA index within a TAG as aforementioned.

In one example, the random access response for the preamble is transmitted in a PDCCH with a CRC that is scrambled by RA-RNTI.

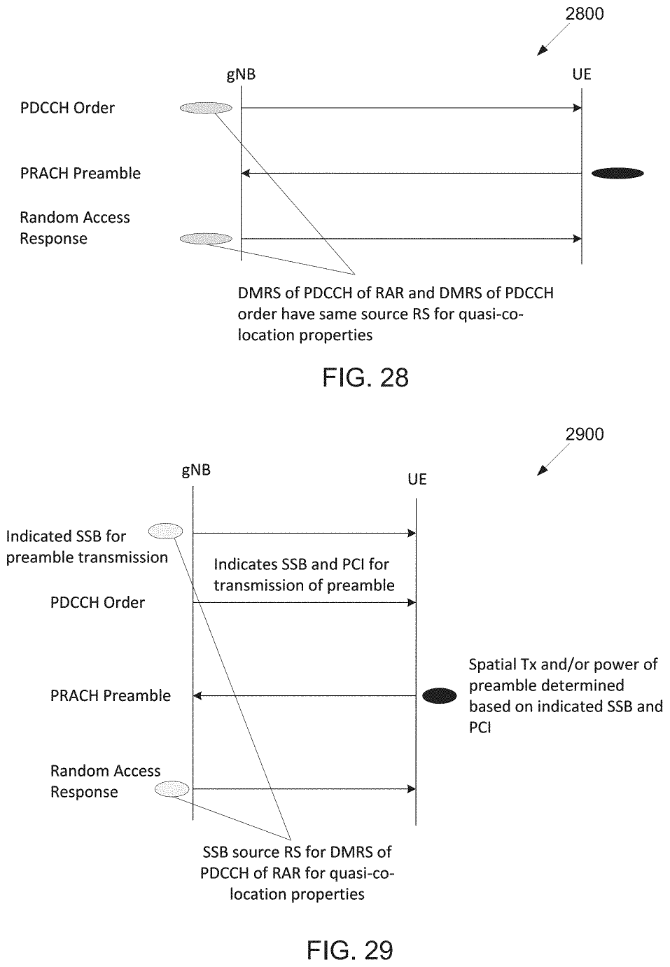

FIG. 28 illustrates yet another example of signaling flow for a preamble transmission based on SS/PBCH block 2800 according to embodiments of the present disclosure, as may be performed by a UE (e.g., 111-116 as illustrated in FIG. 1) and a base station (e.g., 101-103 as illustrated in FIG. 1). An embodiment of the signaling flow for a preamble transmission based on SS/PBCH block 2800 shown in FIG. 28 is for illustration only. One or more of the components illustrated in FIG. 28 can be implemented in specialized circuitry configured to perform the noted functions or one or more of the components can be implemented by one or more processors executing instructions to perform the noted functions.

In one example as illustrated in FIG. 28, the DMRS antenna port of the PDCCH of the RAR has the same antenna port quasi co-location properties as the DMRS antenna port of the PDCCH of the PDCCH order.

FIG. 29 illustrates yet another example of signaling flow for a preamble transmission based on SS/PBCH block 2900 according to embodiments of the present disclosure, as may be performed by a UE (e.g., 111-116 as illustrated in FIG. 1) and a base station (e.g., 101-103 as illustrated in FIG. 1). An embodiment of the signaling flow for a preamble transmission based on SS/PBCH block 2900 shown in FIG. 29 is for illustration only. One or more of the components illustrated in FIG. 29 can be implemented in specialized circuitry configured to perform the noted functions or one or more of the components can be implemented by one or more processors executing instructions to perform the noted functions.

In one example as illustrated in FIG. 29, the DMRS antenna port of the PDCCH of the RAR is quasi-co-located with the SSB and CSI-RS resource used to determine the spatial filter and/or power of the preamble transmission.

In one example, the DMRS antenna port of the PDCCH of the RAR is quasi-co-located with the SSB and CSI-RS resource used to determine the association of the preamble transmission to ROs.

In one example, the DMRS antenna port of the PDCCH of the RAR is quasi-co-located with a CORESET (e.g., based on source RS of TCI state of the CORESET) associated with Type1-PDCCH Common Search Space (CSS) set.

In one example, the DMRS antenna port of the PDCCH of the RAR is quasi-co-located with a CORESET (e.g., based on source RS of TCI state of the CORESET) associated with UE-specific Search Space (USS) set.

In one example, the PDCCH of the RAR is transmitted in a Type1-PDCCH CSS set associated with the serving cell.

In one example, the PDCCH of the RAR is transmitted in a USS set.

In one example, the PDCCH of the RAR is transmitted in the same search space set as that of the PDCCH order.

In one example for a CBRA-based PDCCH order the following examples can apply.

In one example, the preamble is transmitted (e.g., selected by the UE for CBRA PDCCH order) using a spatial filter and/or a power determined based on SS/PBCH index included in (or indicated by) the PDCCH order. The following variants can be considered for this example: (1) variant 1: the same SS/PBCH index is used to (i) determine the PRACH Occasion used to transmit the preamble and (ii) determine the spatial filter and/or a power of the preamble; and (1) variant 2: the PDCCH order includes 2 SS/PBCH indices; (i) One is used to determine the PRACH Occasion used to transmit the preamble and (ii) the other is used to determine the spatial filter and/or a power of the preamble.

In one example, the preamble is transmitted (e.g., selected by the UE for CBRA PDCCH order) using a spatial filter and/or a power determined based on (1) SS/PBCH index, and/or (2) TRP or TAG/TA Flag (or indicator) included in (or indicated by) the PDCCH order. The TRP or TAG/TA Flag (or indicator) indicates whether the preamble is triggered for the TRP sending the PDCCH order or the other TRP, or the flag can indicate which TA/TAG ID or TRP the RACH procedure is triggered for.

The following variants can be considered for this example.

In one example, the same SS/PBCH index is used to (1) determine the PRACH Occasion used to transmit the preamble and (2) determine the spatial filter and/or a power of the preamble.

In one example, the PDCCH order includes 2 SS/PBCH indices; (1) One is used to determine the PRACH Occasion used to transmit the preamble and (2) the other is used to determine the spatial filter and/or a power of the preamble.

In one example, the UE selects an SS/PBCH index associated with the TRP or TAG/TA Flag (or indicator). The selected SS/PBCH index determines the RO to be used for the preamble (based on association between RO and SS/PBCH index) and the spatial filter and/or a power of the preamble transmission.

In one example, the preamble is transmitted using a spatial filter and/or a power determined based on TRP or TAG/TA Flag included in (or indicated by) the PDCCH order. The TRP or TAG/TA Flag (or indicator) indicates whether the preamble is triggered for the TRP sending the PDCCH order or the other TRP, or the flag can indicate which TA/TAG ID or TRP the RACH procedure is triggered for. The UE determines (or selects) an SS/PBCH index to be use for the preamble transmission. The UE selects an SS/PBCH index associated with the TRP or TAG/TA Flag (or indicator). The selected SS/PBCH index determines the RO to be used for the preamble (based on association between RO and SS/PBCH index) and the spatial filter and/or a power of the preamble transmission.

In one example, the preamble is transmitted using a spatial filter and/or a power determined based on an SSB or a CSI-RS resource that the source RS or that is quasi-co-located with the source RS of the PDCCH DM-RS of the PDCCH order.

In one example, the preamble is transmitted using a spatial filter and/or a power determined based on an SSB or a CSI-RS resource. The UE determines (or selects) the SSB or CSI-RS resource such that the SSB or the CSI-RS resource is in the cell as the one of: (1) a source RS of the PDCCH DM-RS of the PDCCH order or (2) a source RS that is quasi-co-located with the source RS of the PDCCH DM-RS of the PDCCH order.

In one example, the preamble is transmitted using a spatial filter and/or a power determined based on an SSB or a CSI-RS resource that the source RS or that is quasi-co-located with the source RS of the PDCCH DM-RS of the PDCCH order.

In one example, the preamble is transmitted using a spatial filter and/or a power determined based on an SSB or a CSI-RS resource. The UE determines (or selects) the SSB or CSI-RS resource such that the SSB or the CSI-RS resource is a TRP as the one of: (1) a source RS of the PDCCH DM-RS of the PDCCH order or (2) a source RS that is quasi-co-located with the source RS of the PDCCH DM-RS of the PDCCH order.

In one example, the preamble is transmitted using a spatial filter and/or a power determined based on an SS/PBCH index or CSI-RS resource, wherein the SS/PBCH index or CSI-RS resource is the source RS for quasi-co-location (e.g., TypeD QCL or TypeA QCL) of a MAC CE activated TCI state, wherein, the activated MAC CE TCI state codepoint (or TCI state or TCI state ID) is included in (or indicated by) the PDCCH order. Active TCI state code points correspond to TCI states activated by MAC CE as described in TS 38.321.

In a variant example, an SSB index is used to determine the spatial filter and/or a power of the transmitted preamble, wherein, the SSB index is root source RS of a TCI state codepoint (or TCI state or TCI state ID) included in (or indicated by) the PDCCH order. The root source RS is a direct or indirect RS for QCL information or spatial relation information of the TCI state codepoint (or TCI state or TCI state ID). A direct RS is when the RS is the source RS of the TCI state codepoint (or TCI state or TCI state ID), an indirect RS, is when the RS provides QCL information or spatial relation information for the source RS of the TCI state codepoint (or TCI state or TCI state ID).

In one example, the preamble is transmitted using a spatial filter and/or a power determined based on an SS/PBCH index or CSI-RS resource, wherein the SS/PBCH index or CSI-RS resource is selected by the UE and belongs to (or associated with) the same TRP as the source RS for quasi-co-location (e.g., TypeD QCL or TypeA QCL) of a MAC CE activated TCI state, wherein, the activated MAC CE TCI state codepoint (or TCI state or TCI state ID) is included in (or indicated by) the PDCCH order. Active TCI state code points correspond to TCI states activated by MAC CE as described in TS 38.321.

In a variant example, an SSB index is used to determine the spatial filter and/or a power of the transmitted preamble, wherein, the SSB index is selected by the UE and belongs to (or associated with) the same TRP as the root source SSB index of a TCI state codepoint (or TCI state or TCI state ID) included in (or indicated by) the PDCCH order. The root source SSB is a direct or indirect RS for QCL information or spatial relation information of the TCI state codepoint (or TCI state or TCI state ID). A direct RS is when the RS is the source RS of the TCI state codepoint (or TCI state or TCI state ID), an indirect RS, is when the RS provides QCL information or spatial relation information for the source RS of the TCI state codepoint (or TCI state or TCI state ID).

In one example, the preamble is transmitted using a spatial filter and/or a power determined based on an SS/PBCH index or CSI-RS resource, wherein the SS/PBCH index or CSI-RS resource is the source RS for spatial relation of a MAC CE activated spatial relation, wherein, the activated MAC CE spatial relation (or spatial relation codepoint or spatial relation ID) is included in (or indicated by) the PDCCH order. In a variant example, an SSB index is used to determine the spatial filter and/or a power of the transmitted preamble, wherein, the SSB index is root source RS of a spatial relation (or spatial relation codepoint or spatial relation ID) included in (or indicated by) the PDCCH order. The root source RS is a direct or indirect RS for QCL information or spatial relation information of the spatial relation (or spatial relation codepoint or spatial relation ID). A direct RS is when the RS is the source RS of the spatial relation (or spatial relation codepoint or spatial relation ID), an indirect RS, is when the RS provides QCL information or spatial relation information for the source RS of the spatial relation (or spatial relation codepoint or spatial relation ID).

In one example, the preamble is transmitted using a spatial filter and/or a power determined based on an SS/PBCH index or CSI-RS resource, wherein the SS/PBCH index or CSI-RS resource is selected by the UE and belongs to (or associated with) the same TRP as the source RS for spatial relation of a MAC CE activated spatial relation, wherein, the activated MAC CE spatial relation (or spatial relation codepoint or spatial relation ID) is included in (or indicated by) the PDCCH order.

In a variant example, an SSB index is used to determine the spatial filter and/or a power of the transmitted preamble, wherein, the SSB index is selected by the UE and belongs to (or associated with) the same TRP as the root source SSB index of a spatial relation (or spatial relation codepoint or spatial relation ID) included in (or indicated by) the PDCCH order. The root source SSB is a direct or indirect RS for QCL information or spatial relation information of the spatial relation (or spatial relation codepoint or spatial relation ID). A direct RS is when the RS is the source RS of the spatial relation (or spatial relation codepoint or spatial relation ID), an indirect RS, is when the RS provides QCL information or spatial relation information for the source RS of the spatial relation (or spatial relation codepoint or spatial relation ID).

In one example, the random access response for the preamble is transmitted in a PDCCH with a CRC that is scrambled by RA-RNTI.

In one example, the DMRS antenna port of the PDCCH of the RAR has the same antenna port quasi co-location properties as the DMRS of the PDCCH antenna port of the PDCCH order.

In one example, the DMRS antenna port of the PDCCH of the RAR is quasi-co-located with the SSB and CSI-RS resource used to determine the spatial filter and/or power of the preamble transmission and/or to determine the association of the preamble transmission to ROs.

In one example, the DMRS antenna port of the PDCCH of the RAR is quasi-co-located with a CORESET (e.g., based on source RS of TCI state of the CORESET) associated with Type 1-PDCCH common search space (CSS) set.

In one example, the PDCCH of the RAR is transmitted in a Type1-PDCCH common search space (CSS) set associated with the serving cell.

In one example, the PDCCH of the RAR is transmitted in the same search space set as that of the PDCCH order.

In one example, the SRS configured a periodic SRS.

In one example, the SRS activated is a semi-persistent SRS. The network activates the semi-persistent SRS when the threshold X is exceeded.

In one example, the SRS triggered is an aperiodic SRS. The network triggers the aperiodic SRS when the threshold X is exceeded.

In one embodiment, a UE is configured to measure the DL delta propagation delay of DL reference signals.

The UE is configured or determines a reference signal (RS1) to use for DL reference timing. For example, the reference signal can be a reference associated with a source RS (e.g., QCL Type D or spatial relation source RS) of an indicated TCI state. The indicated TCI state can be a joint TCI state or an UL TCI state.

The UE detects a reference signal (RS2) with a signal quality (e.g., RSRP or SINR) that exceeds a threshold X, wherein X is configured/update by RRC signaling and/or MAC CE signaling and/or L1 control (DCI) signaling.

The UE measures the “DL delta propagation delay” between RS1 and RS2. If the “DL delta propagation delay” exceeds a threshold Y, wherein Y is configured/update by RRC signaling and/or MAC CE signaling and/or L1 control (DCI) signaling, the UE triggers scheduling request. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. The scheduling request configures or activates or triggers a sounding reference signal (SRS) transmission from the UE for the network to measure the arrival time of the SRS transmitted by the UE at a TRP, and according determine the TA value for transmissions towards the TRP.

In one example, the SRS configured a periodic SRS.

In one example, the SRS activated is a semi-persistent SRS. The network activates the semi-persistent SRS when the threshold X is exceeded.

In one example, the SRS triggered is an aperiodic SRS. The network triggers the aperiodic SRS when the threshold X is exceeded.

In one example, the network can configure an SR (scheduling request) resource for each TRP. The UE can trigger the SR of the TRP for which it would like the network to measure timing information.

In one example, the network can configure one SR (scheduling request) resource. The UE can trigger the SR of a determined TRP (e.g., TRP B) for which the network measures timing information.

In one example, TAG or the TA value associated with an entity (e.g., a TRP or a panel or a cell a CORESETPOOLIndex) is sent from entity associated with the TAG or TA value.

In one example, TAG or the TA value associated with an entity (e.g., a TRP or a panel or a cell a CORESETPOOLIndex) can be sent from another entity not associated with the TAG or TA value.

In one example, two TAGs or the TA values can be sent from the same entity (e.g., a TRP or a panel or a cell a CORESETPOOLIndex). In one example two TAGs or the TA values can be sent from the same entity in a same transmission, e.g., a same MAC CE.

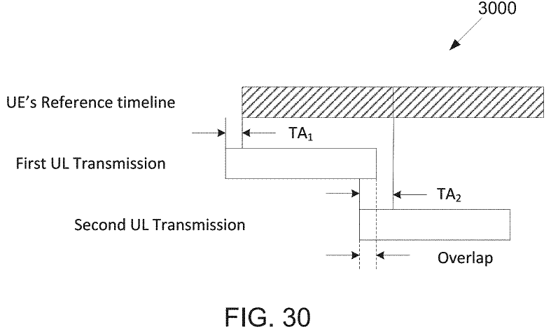

A UE is configured with two TAs, i.e., TA₁ and TA₂. Assume that TA₂ is larger than TA₁, i.e., a UL transmission associated with TA₂ is advanced more than a UL transmission associated with TA₁. If the first UL transmission is followed by the second UL transmission. The two UL transmissions overlap as illustrated in FIG. 30.

FIG. 30 illustrates an example of two UL transmissions overlap 3000 according to embodiments of the present disclosure. The embodiment of the two UL transmissions overlap 3000 illustrated in FIG. 30 is for illustration only.

In NR, with a single TA, UL transmissions in consecutive slots can overlap. For example, if the transmission in a later slot is advanced relative to the transmission of an earlier slot. In this case, the UE shortens the duration later slot as described in TS 38.213—If two adjacent slots overlap due to a TA command, the latter slot is reduced in duration relative to the former slot.

When a UE is signalled a T_{A} value, the relation between the old TA N_{TA,old} and the new TA N_{TA,new}, is given by the following equation, wherein the values are in units of

$${T}_{c} = \frac{{T}_{s}}{64} ≅ 0.51 ns : {N}_{TA , new} = {N}_{TA , old} + \frac{( {T}_{A} - 31 ) \cdot 16 \cdot 64}{{2}^{μ}} , \\ wherein , {T}_{A} = 0 … 63.$$

Therefore, the maximum increase in time advance is 32·16·Tₛ/2^{μ}. μ is the sub-carrier spacing configuration. For example, if μ=0, i.e., 15 kHz sub-carrier spacing, the maximum increase in time advance is 16.7 μs.

In one example, a UE can handle an overlap between consecutive UL transmissions of up to 32·16·

$$\frac{{T}_{s}}{{2}^{μ}} ,$$

wherein μ is the sub-carrier spacing configuration (e.g., by shortening the duration of the later transmission to avoid overlap). The UE is not expected to be configured with a first TA and a second TA that are used for consecutive UL transmissions and that cause an overlap greater than (or greater than or equal to) 32·16·

$$\frac{{T}_{s}}{{2}^{μ}} .$$

In one example, if a UE is configured with a first TA and a second TA that are used for consecutive UL transmissions and that cause an overlap greater than (or greater than or equal to) 32·16·

$$\frac{{T}_{s}}{{2}^{μ}} ,$$

the UE can (or may) drop the second transmission. In another example, if a UE is configured with a first TA and a second TA that are used for consecutive UL transmissions and that cause an overlap greater than (or greater than or equal to) 32·16·

$$\frac{{T}_{s}}{{2}^{μ}} ,$$

the UE can (or may) drop the first transmission or part of the first transmission.

In one example, a UE can handle an overlap between consecutive UL transmissions of up to the duration of one cyclic prefix (CP) (e.g., by shortening the duration of the later transmission to avoid overlap). The UE is not expected to be configured with a first TA and a second TA that are used for consecutive UL transmissions and that cause an overlap greater than (or greater than or equal to) a CP. In one example, if a UE is configured with a first TA and a second TA that are used for consecutive UL transmissions and that cause an overlap greater than (or greater than or equal to) a CP, the UE can (or may) drop the second transmission. In another example, if a UE is configured with a first TA and a second TA that are used for consecutive UL transmissions and that cause an overlap greater than (or greater than or equal to) CP, the UE can (or may) drop the first transmission or part of the first transmission.

In one example, a UE can handle an overlap between consecutive UL transmissions of up to the duration of half a cyclic prefix (CP) (e.g., by shortening the duration of the later transmission to avoid overlap). The UE is not expected to be configured with a first TA and a second TA that are used for consecutive UL transmissions and that cause an overlap greater than (or greater than or equal to) a CP/2. In one example, if a UE is configured with a first TA and a second TA that are used for consecutive UL transmissions and that cause an overlap greater than (or greater than or equal to) a CP/2, the UE can (or may) drop the second transmission. In another example, if a UE is configured with a first TA and a second TA that are used for consecutive UL transmissions and that cause an overlap greater than (or greater than or equal to) CP/2, the UE can (or may) drop the first transmission or part of the first transmission.

In one example, a UE can handle an overlap between consecutive UL transmissions of up to the duration of length T (e.g., by shortening the duration of the later transmission to avoid overlap). The UE is not expected to be configured with a first TA and a second TA that are used for consecutive UL transmissions and that cause an overlap greater than (or greater than or equal to) T. In one example, if a UE is configured with a first TA and a second TA that are used for consecutive UL transmissions and that cause an overlap greater than (or greater than or equal to) T, the UE can (or may) drop the second transmission. In another example, if a UE is configured with a first TA and a second TA that are used for consecutive UL transmissions and that cause an overlap greater than (or greater than or equal to) T, the UE can (or may) drop the first transmission or part of the first transmission.

In one sub-example, the UE indicates the value of T that it can support. In one example, T can be zero, in which case the UE does not support any overlap between UL transmissions. In one example, T can be signalled as infinity, in which case the UE can support any size overlap between consecutive UL transmissions. In one example, if T is infinity, the UE can transmit both UL transmissions in the overlap region (e.g., there is no dropping of transmissions or parts of transmissions).

In one sub-example, the network configures T through RRC signalling and/or MAC CE signalling and/or L1 control (e.g., DCI) signalling.

In one sub-example, the UE indicates the value of for T that it can support, e.g., Tₘₐₓ. The network configures T through RRC signalling and/or MAC CE signalling and/or L1 control (e.g., DCI) signalling such that T≤Tₘₐₓ, or T<Tₘₐₓ.

In one sub-example, T is fraction of the CP length. For example, T=f·CP, where f is the value signalled by the UE or signalled to the UE.

In one example, a UE can signal if it can support simultaneous reception of UL transmissions that are overlapping.

In one example, a network, through scheduling restrictions, can avoid making the overlap between UL transmissions exceed the maximum overlap a UE can support.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive configuration information for a first list of synchronization signal/physical broadcast channel (SS/PBCH) block indices associated with a first timing advance group (TAG) and a second list of SS/PBCH block indices associated with a second TAG,
receive a contention free random access (CFRA)-based physical downlink control channel (PDCCH) order,
transmit a physical random access channel (PRACH) preamble in response to the CFRA-based PDCCH order, and
receive a random access response (RAR) in response to the PRACH preamble, including a timing advance (TA) command; and
a processor operably coupled to the transceiver, the processor configured to determine a TAG associated with the TA command based on an SS/PBCH block index associated with the CFRA-based PDCCH order.

2. The UE of claim 1, wherein:
a demodulation reference signal (DM-RS) of the CFRA-based PDCCH order is associated with a channel state information-reference signal (CSI-RS) for quasi-collocation (QCL),
the CSI-RS is QCLed with an SS/PBCH block associated with an index from the first list or the second list, and
the TAG is determined based on the configuration information and the index of the SS/PBCH block.

3. The UE of claim 1, wherein:
the TAG is determined based on the configuration information and a SS/PBCH index included in a downlink control information (DCI) format of the CFRA-based PDCCH order, and
the SS/PBCH index is from the first list or the second list.

4. The UE of claim 1, wherein:
the processor is further configured to determine, based on a SS/PBCH index included in a downlink control information (DCI) format of the CFRA-based PDCCH order, a PRACH occasion,
the transceiver is further configured to transmit the PRACH preamble in the PRACH occasion, and
a power for transmission of the PRACH preamble is based on a downlink reference signal used for quasi-colocation of a demodulation reference signal (DM-RS) of the PDCCH order.

5. The UE of claim 1, wherein a PDCCH of the RAR is received in a Type1 common search space (CSS) set.

6. The UE of claim 1, wherein a PDCCH demodulation reference signal (DM-RS) of the RAR has a same downlink reference signal for quasi-colocation as a DM-RS of the CFRA-based PDCCH order.

7. The UE of claim 1, wherein:
a first uplink (UL) transmission is associated with the first TAG, and a second UL transmission is associated with the second TAG,
the processor is further configured to determine:
a TA of the first TAG and a TA of the second TAG,
that the TA of the second TAG exceeds the TA of the first TAG by at least a value T, and
the transceiver is further configured to based on determination that the TA of the second TAG exceeds the TA of the second TAG, transmit the first UL transmission and drop the second UL transmission.

8. A base station (BS), comprising:
a transceiver configured to:
transmit configuration information for a first list of synchronization signal/physical broadcast channel (SS/PBCH) block indices associated with a first timing advance group (TAG) and a second list of SS/PBCH block indices associated with a second TAG,
transmit a contention free random access (CFRA)-based physical downlink control channel (PDCCH) order,
receive a physical random access channel (PRACH) preamble in response to the CFRA-based PDCCH order, and
transmit a random access response (RAR) in response to the PRACH preamble, including a timing advance (TA) command; and
a processor operably coupled to the transceiver, the processor configured to determine a TAG associated with the TA command based on an SS/PBCH block index associated with the CFRA-based PDCCH order.

9. The BS of claim 8, wherein:
a demodulation reference signal (DM-RS) of the CFRA-based PDCCH order is associated with a channel state information-reference signal (CSI-RS) for quasi-collocation (QCL),
the CSI-RS is QCLed with an SS/PBCH block associated with an index from the first list or the second list, and
the TAG is determined based on the configuration information and the index of the SS/PBCH block.

10. The BS of claim 8, wherein:
the TAG is determined based on the configuration information and a SS/PBCH index included in a downlink control information (DCI) format of the CFRA-based PDCCH order, and
the SS/PBCH index is from the first list or the second list.

11. The BS of claim 8, wherein:
the processor is further configured to determine, based on a SS/PBCH index included in a downlink control information (DCI) format of the CFRA-based PDCCH order, a PRACH occasion,
the transceiver is further configured to receive the PRACH preamble in the PRACH occasion, and
a power for transmission of the PRACH preamble is based on a downlink reference signal used for quasi-colocation of a demodulation reference signal (DM-RS) of the PDCCH order.

12. The BS of claim 8, wherein a PDCCH of the RAR is transmitted in a Type1 common search space (CSS) set.

13. The BS of claim 8, wherein a PDCCH demodulation reference signal (DM-RS) of the RAR has a same downlink reference signal for quasi-colocation as a DM-RS of the CFRA-based PDCCH order.

14. The BS of claim 8, wherein:
a first uplink (UL) reception is associated with the first TAG, and a second UL reception is associated with the second TAG,
the processor is further configured to determine:
a TA of the first TAG and a TA of the second TAG, and
that the TA of the second TAG exceeds the TA of the first TAG by at least a value T, and
the transceiver is further configured to based on determination that the TA of the second TAG exceeds the TA of the second TAG, receive the first UL reception and not receive the second UL reception.

15. A method of operating a user equipment (UE), the method comprising:
receiving configuration information for a first list of synchronization signal/physical broadcast channel (SS/PBCH) block indices associated with a first timing advance group (TAG) and a second list of SS/PBCH block indices associated with a second TAG,
receiving a contention free random access (CFRA)-based physical downlink control channel (PDCCH) order,
transmitting a physical random access channel (PRACH) preamble in response to the CFRA-based PDCCH order,
receiving a random access response (RAR) in response to the PRACH preamble, including a timing advance (TA) command, and
determining a TAG associated with the TA command based on an SS/PBCH block index associated with the CFRA-based PDCCH order.

16. The method of claim 15, wherein:
a demodulation reference signal (DM-RS) of the CFRA-based PDCCH order is associated with a channel state information-reference signal (CSI-RS) for quasi-collocation (QCL),
the CSI-RS is QCLed with an SS/PBCH block associated with an index from the first list or the second list, and
the TAG is determined based on the configuration information and the index of the SS/PBCH block.

17. The method of claim 15, wherein:
the TAG is determined based on the configuration information and a SS/PBCH index included in a downlink control information (DCI) format of the CFRA-based PDCCH order, and
the SS/PBCH index is from the first list or the second list.

18. The method of claim 15, further comprising:
determining, based on a SS/PBCH index included in a downlink control information (DCI) format of the CFRA-based PDCCH order, a PRACH occasion; and
transmitting the PRACH preamble in the PRACH occasion,
wherein a power for transmission of the PRACH preamble is based on a downlink reference signal used for quasi-colocation of a demodulation reference signal (DM-RS) of the PDCCH order.

19. The method of claim 15, wherein:
a PDCCH of the RAR is received in a Type1 common search space (CSS) set, and
a PDCCH demodulation reference signal (DM-RS) of the RAR has a same downlink reference signal for quasi-colocation as a DM-RS of the CFRA-based PDCCH order.

20. The method of claim 15, wherein a first uplink (UL) transmission is associated with the first TAG, and a second UL transmission is associated with the second TAG, the method further comprising:
determining a TA of the first TAG and a TA of the second TAG;
determining that the TA of the second TAG exceeds the TA of the first TAG by at least a value T; and
transmitting the first UL transmission and dropping the second UL transmission based on determination that the TA of the second TAG exceeds the TA of the second TAG.
